(19) United States
(12) Patent Application Publication
(10) Pub. No.: US 2018/0341400 A1
(43) Pub. Date: Nov. 29, 2018

(54) ELECTRONIC DEVICE FOR SELECTING EXTERNAL DEVICE AND CONTROLLING THE SAME AND OPERATING METHOD THEREOF

(71) Applicant: SAMSUNG ELECTRONICS CO., LTD., Suwon-si (KR)

(72) Inventors: Sangheon KIM, Gumi-si (KR); Sung-Jun KIM, Daegu (KR); Jong-Wu BAEK, Gumi-si (KR); Youngdae LEE, Daegu (KR); Eun-Yeung LEE, Gumi-si (KR); In-Hyung JUNG, Gumi-si (KR); Ho-Chang CHAE, Hwaseong-si (KR); Cheongjae LEE, Daegu (KR)

(21) Appl. No.: 15/989,489

(22) Filed: May 25, 2018

(30) Foreign Application Priority Data
May 26, 2017 (KR) 10-2017-0065585

(51) Int. Cl. G06F 3/0488; G06F 3/0484

(52) U.S. Cl. CPC G06F 3/04883; G06F 3/03545; G06F 3/0484

(57) ABSTRACT

Various embodiments of the present disclosure relate to an electronic device for controlling an external electronic device using a user input, and an operating method thereof. An electronic device according to various embodiments of the present disclosure may include a housing, a touchscreen display exposed through the housing, a communication circuit, a processor disposed inside the housing and electrically coupled with the display and the wireless communication circuit, and a memory disposed inside the housing and electrically coupled with the processor. The memory may store instructions which, when executed by the processor, cause the electronic device to provide a user interface for receiving a user handwriting input, to receive a first handwriting input of a first object through the display, to determine a shape of the first object, to select an external electronic device to control based on the shape of the first object, and to establish wireless communication with the external electronic device to control, through the communication circuit.

### CROSS-REFERENCE TO RELATED APPLICATION

This application is based on and claims priority under 35 U.S.C. § 119 to Korean Patent Application No. 10-2017-0065585, filed on May 26, 2017, in the Korean Intellectual Property Office, the disclosure of which is incorporated by reference herein in its entirety.

### TECHNICAL FIELD

The disclosure relates to an electronic device for selecting and controlling an external electronic device using a user input, and an operating method thereof.

BACKGROUND As portable electronic devices such as smart phones exhibit high performance, the electronic devices provide various services. For example, in addition to basic services such as call and text messaging, more complicated services such as game, messenger, document editing, and image/video play and editing are provided.

In addition, development of a wireless Internet service changes a content service method. Electronic device users may not only play content in the electronic device but also exchange information with electronic devices accessed to a network and use context-based services.

For the context-based service, various user inputs are used besides touch input. For example, the various user inputs include text input, voice input, gesture input, eye tracking, electroencephalography (EEG), electromyogram (EMG), and so on.

If the text input is used for the context-based service, repeated operations may cause inconvenience to the user. In many cases, a system which provides the service based on the voice input may cause user discomfort due to ambient noise or the voice input in the presence of others.

### SUMMARY

To address the above-discussed deficiencies of the prior art, it is an example aspect of the present disclosure to provide a method and an apparatus for receiving a user's input and selecting and/or controlling an external electronic device to control based on the user's input.

According to an aspect of the present disclosure, an electronic device may include a housing, a touchscreen display exposed through part of the housing, a wireless communication circuit, a processor disposed inside the housing and electrically coupled with the display and the wireless communication circuit, and a memory disposed inside the housing and electrically coupled with the processor. The memory may store instructions which, when executed by the processor, cause the electronic device to provide a user interface configured to receive a user handwriting input, to receive a first handwriting input of a first object through the display, to determine a shape of the first object, to select an external electronic device to control based on the shape of the first object, and to establish, via the wireless communication circuit, wireless communication with the external electronic device.

According to another aspect of the present disclosure, a method for operating an electronic device may include providing a user interface configured to receive a user handwriting input, receiving a first handwriting input of a first object through a display, determining a shape of the first object, selecting an external electronic device to control based on the shape of the first object, and establishing wireless communication with the external electronic device, using a wireless communication circuit.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a diagram illustrating an electronic device in a network environment according to various embodiments of the present disclosure;

FIG. 2 is a block diagram illustrating an electronic device according to various embodiments of the present disclosure;

FIG. 3 is a block diagram illustrating a program module according to various embodiments of the present disclosure;

FIG. 4 is a diagram illustrating an electronic device and a server according to various embodiments of the present disclosure;

FIG. 5 is a signal flow diagram illustrating signal flows between an electronic device, a server, and an external electronic device according to various embodiments of the present disclosure;

FIG. 6 is a block diagram illustrating an electronic device according to various embodiments of the present disclosure;

FIG. 7 is a diagram illustrating information stored in a storage unit of an electronic device according to various embodiments of the present disclosure;

FIG. 8 is a diagram illustrating shape information stored in a storage unit of an electronic device according to various embodiments of the present disclosure;

FIG. 9 is a diagram illustrating location information of external devices and location information of an electronic device, which are stored in a storage unit of the electronic device according to various embodiments of the present disclosure;

FIGS. 10 and 11 are diagrams illustrating operation information of action information stored in a storage unit of an electronic device according to various embodiments of the present disclosure;

FIG. 12 is a flowchart illustrating operations of an electronic device for controlling an external electronic device using a user's handwriting input according to various embodiments of the present disclosure;

FIG. 13 is a flowchart illustrating operations of an electronic device for controlling an external electronic device using a user's handwriting input according to various embodiments of the present disclosure;

FIG. 14 is a diagram illustrating a concept for recognizing a shape of a first object or a second object in an electronic device according to various embodiments of the present disclosure;

FIG. 15 is a diagram illustrating a concept for recognizing a shape of a first object or a second object in an electronic device according to various embodiments of the present disclosure;

FIGS. 16A, 16B, 16C and 16D are diagrams illustrating a concept for determining a shape of an object in an electronic device according to various embodiments of the present disclosure;

FIG. 17 is a flowchart illustrating operations of an electronic device for receiving a first handwriting input which draws a first subject according to various embodiments of the present disclosure;

FIG. 18 is a flowchart illustrating operations of an electronic device for receiving a first handwriting input which draws a first subject according to various embodiments of the present disclosure;

FIG. 19 is a flowchart illustrating operations of an electronic device for receiving a first handwriting input which draws a first subject according to various embodiments of the present disclosure;

FIGS. 20A and 20B are diagrams illustrating modification of shape candidates in an electronic device according to various embodiments of the present disclosure;

FIG. 21 is a flowchart illustrating operations of an electronic device for controlling an external electronic device according to various embodiments of the present disclosure;

FIG. 22 is a flowchart illustrating operations of an electronic device for controlling at least one of an external electronic device and the electronic device according to various embodiments of the present disclosure;

FIGS. 23A, 23B and 23C are diagrams illustrating a user interface provided by an electronic device to determine an operation and a parameter value according to various embodiments of the present disclosure;

FIGS. 24A, 24B and 24C are diagram illustrating an example where an electronic device determines an operation and a parameter value based on a user input for a user interface according to various embodiments of the present disclosure;

FIG. 25 is a flowchart illustrating operations of an electronic device for providing a user interface to control an external electronic device according to various embodiments of the present disclosure;

FIG. 26 is a diagram illustrating a user interface provided by an electronic device to control an external electronic device according to various embodiments of the present disclosure;

FIG. 27 is a diagram illustrating status information of an eternal electronic device, which is displayed at an electronic device according to various embodiments of the present disclosure;

FIG. 28 is a flowchart illustrating operations of an electronic device for controlling an external electronic device based on a user's voice input according to various embodiments of the present disclosure;

FIGS. 29A, 29B and 29C are diagrams illustrating an example where an electronic device controls an external electronic device based on a user's voice input according to various embodiments of the present disclosure;

FIGS. 30A, 30B and 30C are diagrams illustrating another example where an electronic device controls an external electronic device based on a user's voice input according to various embodiments of the present disclosure;

FIG. 31 is a flowchart illustrating operations of an electronic device for controlling an external electronic device according to various embodiments of the present disclosure;

FIG. 32 is a flowchart illustrating operations of an electronic device for mapping a first object to an external electronic device according to various embodiments of the present disclosure;

FIG. 33 is a diagram illustrating an example where an electronic device determines a shape of an external electronic device corresponding to a first object according to various embodiments of the present disclosure;

FIG. 34 is a flowchart illustrating operations of an electronic device for determining an external electronic device to be mapped to a first object according to various embodiments of the present disclosure;

FIGS. 35A, 35B and 35C are diagrams illustrating an example where an electronic device determines an external electronic device to be mapped to a first object according to various embodiments of the present disclosure;

FIG. 36 is a flowchart illustrating operations of an electronic device for determining a shape of an external electronic device corresponding to a first object according to various embodiments of the present disclosure; and

FIGS. 37A, 37B, 37C and 37D are diagrams illustrating an example where an electronic device controls an external electronic device according to various embodiments of the present disclosure.

Throughout the drawings, like reference numerals will be understood to refer to like parts, components and structures.

### DETAILED DESCRIPTION

Example embodiments of the present disclosure are described in greater detail below with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure. The terms used herein are defined in consideration of functions of the present disclosure and may vary depending on a user's or an operator's intension and usage. Therefore, the terms used herein should be understood based on the descriptions made herein. It is to be understood that the singular forms “a,” “an,” and “the” include plural referents unless the context clearly dictates otherwise. In the present disclosure, an expression such as “A or B,” “at least one of A and B,” or “one or more of A and B” may include all possible combinations of the listed items. Expressions such as “first,” “second,” “primarily,” or “secondary,” as used herein, may be used to represent various elements regardless of order and/or importance and do not limit corresponding elements. The expressions may be used for distinguishing one element from another element. When it is described that an element (such as a first element) is “(operatively or communicatively) coupled” to or “connected” to another element (such as a second element), the element can be directly connected to the other element or can be connected through another element (such as a third element).

An expression “configured to (or set)” used in the present disclosure may be used interchangeably with, for example, “suitable for,” “having the capacity to,” “designed to,” “adapted to,” “made to,” or “capable of” according to a situation. A term “configured to (or set)” does not only refer to “specifically designed to” by hardware. In some situations, the expression “apparatus configured to” may refer to a situation in which the apparatus “can” operate together with another apparatus or component. For example, a phrase “a processor configured (or set) to perform A, B, and C” may refer, for example, and without limitation, to a generic-purpose processor (such as a Central Processing Unit (CPU) or an application processor) that can perform a corresponding operation by executing at least one software program stored at an exclusive processor (such as an embedded processor) for performing a corresponding operation or at a memory device.

An electronic device according to embodiments of the present disclosure, may be embodied as, for example, at least one of a smart phone, a tablet Personal Computer (PC), a mobile phone, a video phone, an e-book reader, a desktop PC, a laptop PC, a netbook computer, a workstation, a server, a Personal Digital Assistant (PDA), a Portable Multimedia Player (PMP), an MPEG 3 (MP3) player, a medical equipment, a camera, and a wearable device. The wearable device can include at least one of an accessory type (e.g., a watch, a ring, a bracelet, an ankle bracelet, a necklace, glasses, a contact lens, or a Head-Mounted-Device (HMD)), a fabric or clothing embedded type (e.g., electronic garments), a body attachable type (e.g., a skin pad or a tattoo), and an implantable circuit, or the like, but is not limited thereto. The electronic device may be embodied as at least one of, for example, a television, a Digital Versatile Disc (DVD) player, an audio device, a refrigerator, an air-conditioner, a cleaner, an oven, a microwave oven, a washing machine, an air cleaner, a set-top box, a home automation control panel, a security control panel, a media box (e.g., Samsung HomeSync™, Apple TV™, or Google TV™), a game console (e.g., Xbox™, PlayStation™), an electronic dictionary, an electronic key, a camcorder, and an electronic frame, or the like, but is not limited thereto.

According to various example embodiments, the electronic device may be embodied as at least one of various medical devices (such as, various portable medical measuring devices (a blood sugar measuring device, a heartbeat measuring device, a blood pressure measuring device, or a body temperature measuring device), a Magnetic Resonance Angiography (MRA) device, a Magnetic Resonance Imaging (MRI) device, a Computed Tomography (CT) device, a scanning machine, and an ultrasonic wave device), a navigation device, a Global Navigation Satellite System (GNSS), an Event Data Recorder (EDR), a Flight Data Recorder (FDR), a vehicle infotainment device, electronic equipment for ship (such as, a navigation device for ship and gyro compass), avionics, a security device, a head unit for a vehicle, an industrial or home robot, a drone, an Automated Teller Machine (ATM) of a financial institution, a Point Of Sales (POS) device of a store, and an Internet of Things (IoT) device (e.g., a light bulb, various sensors, a sprinkler device, a fire alarm, a thermostat, a street light, a toaster, sports equipment, a hot water tank, a heater, and a boiler), or the like, but is not limited thereto. According to an embodiment, the electronic device may be embodied as at least one of a portion of furniture, building/construction or vehicle, an electronic board, an electronic signature receiving device, a projector, and various measuring devices (e.g., water supply, electricity, gas, or electric wave measuring device), or the like, but is not limited thereto. An electronic device, according to an embodiment, can be a flexible electronic device or a combination of two or more of the foregoing various devices. An electronic device, according to an embodiment of the present disclosure, is not limited to the foregoing devices may be embodied as a newly developed electronic device. The term “user”, as used herein, can refer to a person using an electronic device or a device using an electronic device (e.g., an artificial intelligence electronic device).

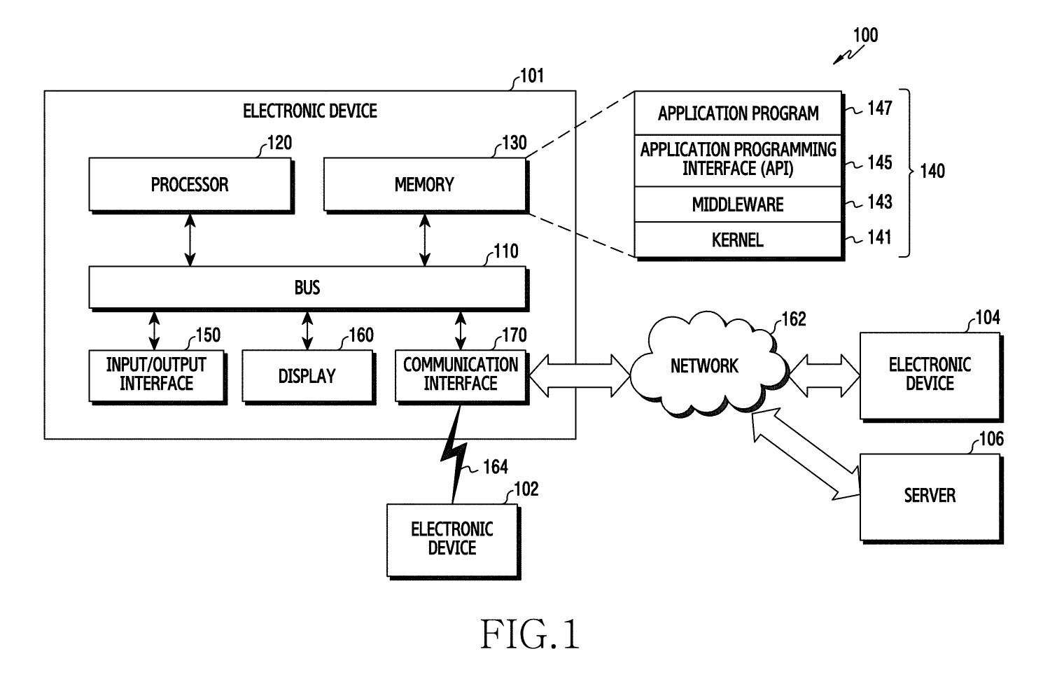

Referring initially to FIG. 1, an electronic device 101 resides in a network environment 100. The electronic device 101 can include a bus 110, a processor (e.g., including processing circuitry) 120, a memory 130, an input/output interface (e.g., including input/output circuitry) 150, a display 160, and a communication interface (e.g., including communication circuitry) 170. The electronic device 101 may be provided without at least one of the components, or may include at least one additional component.

The bus 110 can include a circuit for connecting the components 120 through 170 and delivering communication signals (e.g., control messages or data) therebetween.

The processor 120 may include various processing circuitry, such as, for example, and without limitation, one or more of a dedicated processor, a CPU, an application processor, and/or a Communication Processor (CP), or the like. The processor 120, for example, can perform an operation or data processing with respect to control and/or communication of at least another component of the electronic device 101.

The memory 130 may include a volatile and/or nonvolatile memory. The memory 130, for example, can store commands or data relating to at least another component of the electronic device 101. According to an embodiment, the memory 130 can store software and/or a program 140. The program 140 can include, for example, a kernel 141, middleware 143, an Application Programming Interface (API) 145, and/or an application program (or “application”) 147. At least part of the kernel 141, the middleware 143, or the API 145 can be referred to as an Operating System (OS). The kernel 141 can control or manage system resources (e.g., the bus 110, the processor 120, or the memory 130) used for performing operations or functions implemented by the other programs (e.g., the middleware 143, the API 145, or the application program 147). Additionally, the kernel 141 can provide an interface for controlling or managing system resources by accessing an individual component of the electronic device 101 from the middleware 143, the API 145, or the application program 147.

The middleware 143, for example, can serve an intermediary role for exchanging data between the API 145 or the application program 147 and the kernel 141 through communication. Additionally, the middleware 143 can process one or more job requests received from the application program 147, based on their priority. For example, the middleware 143 can assign a priority for using a system resource (e.g., the bus 110, the processor 120, or the memory 130) of the electronic device 101 to at least one of the application programs 147, and process the one or more job requests. The API 145, as an interface through which the application 147 controls a function provided from the kernel 141 or the middleware 143, can include, for example, at least one interface or function (e.g., an instruction) for file control, window control, image processing, or character control. The input/output interface 150, for example, can deliver commands or data inputted from a user or another external device to other component(s) of the electronic device 101, or output commands or data inputted from the other component(s) of the electronic device 101 to the user or another external device.

The display 160, for example, can include a Liquid Crystal Display (LCD), a Light Emitting Diode (LED) display, an Organic Light Emitting Diode (OLED) display, a MicroElectroMechanical Systems (MEMS) display, or an electronic paper display, or the like, but is not limited thereto. The display 160, for example, can display various contents (e.g., texts, images, videos, icons, and/or symbols) to the user. The display 160 can include a touch screen, for example, and receive touch, gesture, proximity, or hovering inputs by using an electronic pen or a user's body part.

The communication interface 170, for example, can set a communication between the electronic device 101 and an external device (e.g., a first external electronic device 102, a second external electronic device 104, or a server 106). For example, the communication interface 170 can communicate with the external device (e.g., the second external electronic device 104 or the server 106) over a network 162 through wireless communication or wired communication. The communication interface 170 may also establish a short-range wireless communication connection 164 between, for example, and without limitation, the electronic device 101 and the first external electronic device 102.

The wireless communication, for example, can include cellular communication using at least one of Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro), or Global System for Mobile Communications (GSM). The wireless communication can include, for example, at least one of Wireless Fidelity (WiFi), Bluetooth, Bluetooth Low Energy (BLE), Zigbee, Near Field Communication (NFC), magnetic secure transmission, Radio Frequency (RF), and Body Area Network (BAN). The wireless communication can include GNSS. The GNSS can include, for example, Global Positioning System (GPS), Global Navigation Satellite System (GLONASS), Beidou navigation satellite system (Beidou), or Galileo (the European global satellite-based navigation system). Hereafter, the GPS can be interchangeably used with the GNSS. The wired communication, for example, can include at least one of Universal Serial Bus (USB), High Definition Multimedia Interface (HDMI), Recommended Standard 232 (RS-232), power line communications, and Plain Old Telephone Service (POTS). The network 162 can include a telecommunications network, for example, at least one of computer network (e.g., LAN or WAN), Internet, and telephone network.

Each of the first and second external electronic devices 102 and 104 can be of the same as or of a different type from that of the electronic device 101. According to embodiments of the present disclosure, all or part of operations executed in the electronic device 101 can be executed by another electronic device or a plurality of electronic devices (e.g., the electronic device 102 or 104, or the server 106). To perform a function or service automatically or by request, instead of performing the function or the service by the electronic device 101, the electronic device 101 can request at least part of a function relating thereto from another device (e.g., the electronic device 102 or 104, or the server 106). The other electronic device (e.g., the electronic device 102 or 104, or the server 106) can perform the requested function or an additional function and send its result to the electronic device 101. The electronic device 101 can provide the requested function or service by processing the received result. In doing so, for example, cloud computing, distributed computing, or client-server computing techniques can be used.

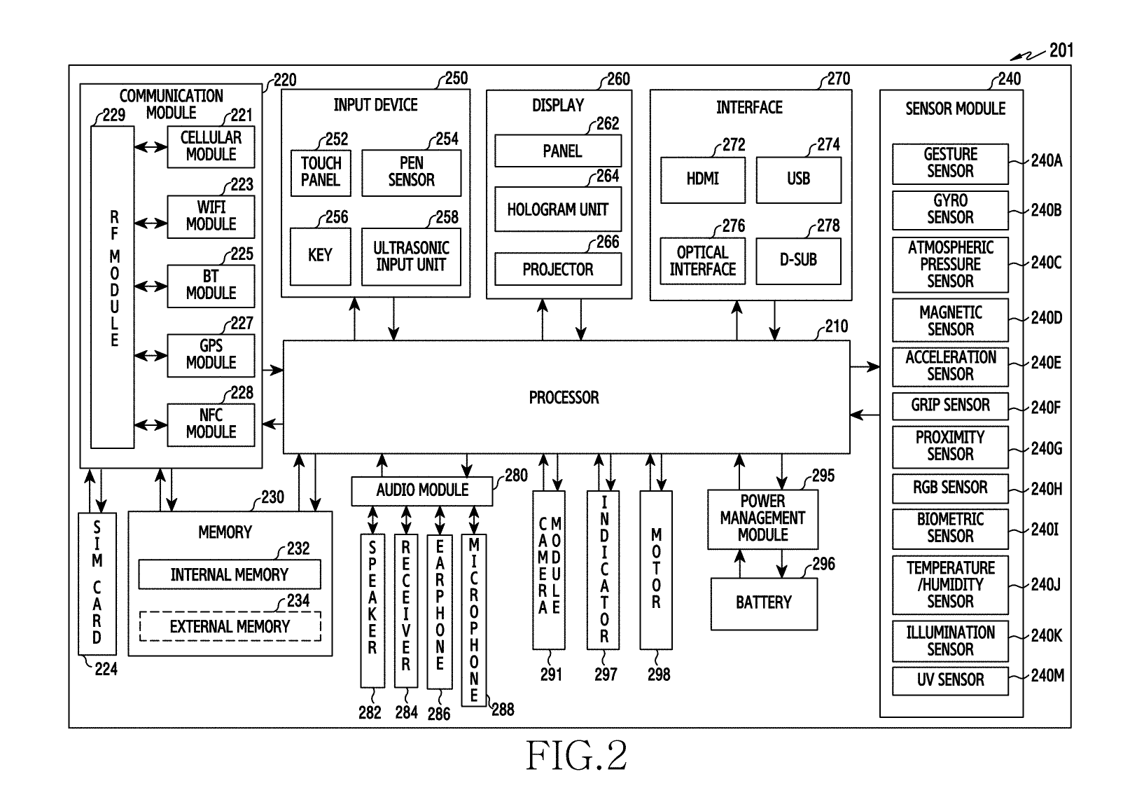

FIG. 2 is a block diagram illustrating an electronic device 201 according to an embodiment of the present disclosure. The electronic device 201, for example, can include all or part of the above-described electronic device 101 of FIG. 1. The electronic device 201 includes one or more processors (e.g., an AP) (e.g., including processing circuitry) 210, a communication module (e.g., including communication circuitry) 220, a Subscriber Identification Module (SIM) 224, a memory 230, a sensor module 240, an input device (e.g., including input circuitry) 250, a display 260, an interface (e.g., including interface circuitry) 270, an audio module 280, a camera module 291, a power management module 295, a battery 296, an indicator 297, and a motor 298.

The processor 210, for example, may include various processing circuitry and control a plurality of hardware or software components connected to the processor 210, and also can perform various data processing and operations by executing an OS or an application program. The processor 210 can be implemented with a System on Chip (SoC), for example. The processor 210 can further include a Graphic Processing Unit (GPU) and/or an image signal processor. The processor 210 may include at least part (e.g., a cellular module 221) of the components shown in FIG. 2. The processor 210 can load commands or data received from at least one other component (e.g., a nonvolatile memory) into a volatile memory, process them, and store various data in the nonvolatile memory.

The communication module 220 can have the same or similar configuration to the communication interface 170 of FIG. 1. The communication module 220 may include various components including various communication circuitry, such as, for example, and without limitation, the cellular module 221, a WiFi module 223, a Bluetooth (BT) module 225, a GPS (GNSS) module 227, an NFC module 228, and an RF module 229. The cellular module 221, for example, can provide voice call, video call, Short Message Service (SMS), or Internet service through a communication network. The cellular module 221 can identify and authenticate the electronic device 201 in a communication network by using the SIM (e.g., a SIM card) 224. The cellular module 221 can perform at least part of a function that the processor 210 provides. The cellular module 221 can further include a CP. At least some (e.g., two or more) of the cellular module 221, the WiFi module 223, the BT module 225, the GNSS (GPS) module 227, and the NFC module 228 can be included in one Integrated Circuit (IC) or an IC package. The RF module 229, for example, can transmit/receive a communication signal (e.g., an RF signal). The RF module 229, for example, can include a transceiver, a Power Amp Module (PAM), a frequency filter, a Low Noise Amplifier (LNA), or an antenna. According to another embodiment, at least one of the cellular module 221, the WiFi module 223, the BT module 225, the GNSS module 227, and the NFC module 228 can transmit/receive an RF signal through an additional RF module.

The SIM 224, for example, can include a card including a SIM or an embedded SIM, and also can contain unique identification information (e.g., an Integrated Circuit Card Identifier (ICCID)) or subscriber information (e.g., an International Mobile Subscriber Identity (IMSI)).

The memory 230 (e.g., the memory 130) can include at least one of an internal memory 232 and/or an external memory 234. The internal memory 232 can include at least one of, for example, a volatile memory (e.g., Dynamic RAM (DRAM), Static RAM (SRAM), or Synchronous Dynamic RAM (SDRAM)), and a non-volatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, flash memory, hard drive, and solid state drive (SSD)). The external memory 234 can include flash drive, for example, Compact Flash (CF), Secure Digital (SD), micro SD, mini SD, extreme digital (xD), Multi-Media Card (MMC), or memory stick. The external memory 234 can be functionally or physically connected to the electronic device 201 through various interfaces.

The sensor module 240 can, for example, measure physical quantities or detect an operating state of the electronic device 201, and thus convert the measured or detected information into electrical signals. The sensor module 240 can include, for example, and without limitation, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a Red, Green, Blue (RGB) sensor), a biometric sensor 2401, a temperature/humidity sensor 240J, an illumination sensor 240K, and/or an Ultra Violet (UV) sensor 240M, or the like. Additionally or alternately, the sensor module 240 can include an E-nose sensor, an Electromyography (EMG) sensor, an Electroencephalogram (EEG) sensor, an Electrocardiogram (ECG) sensor, an InfraRed (IR) sensor, an iris sensor, and/or a fingerprint sensor. The sensor module 240 can further include a control circuit for controlling at least one sensor therein. The electronic device, as part of the processor 210 or individually, can further include a processor configured to control the sensor module 240 and thus control the sensor module 240 while the processor 210 is sleeping.

The input device 250 may include various input circuitry, such as, for example, and without limitation, one or more of a touch panel 252, a (digital) pen sensor 254, a key 256, and/or an ultrasonic input device 258, or the like. The touch panel 252 can use at least one of, for example, capacitive, resistive, infrared, and ultrasonic methods. Additionally, the touch panel 252 can further include a control circuit. The touch panel 252 can further include a tactile layer to provide a tactile response to a user. The (digital) pen sensor 254 can include, for example, part of a touch panel or a sheet for recognition. The key 256 can include, for example, a physical button, a touch key, an optical key, or a keypad. The ultrasonic input device 258 can detect ultrasonic waves from an input means through a microphone 288 and check data corresponding to the detected ultrasonic waves.

The display 260 (e.g., the display 160) can include at least one of a panel 262, a hologram device 264, a projector 266, and/or a control circuit for controlling them. The panel 262 can be implemented to be flexible, transparent, or wearable, for example. The panel 262 and the touch panel 252 can be configured with one or more modules. The panel 262 can include a pressure sensor (or a force sensor) for measuring a pressure of the user touch. The pressure sensor can be integrated with the touch panel 252, or include one or more sensors separately from the touch panel 252. The hologram device 264 can show three-dimensional images in the air by using the interference of light. The projector 266 can display an image by projecting light on a screen. The screen, for example, can be placed inside or outside the electronic device 201.

The interface 270 may include various interface circuitry, such as, for example, and without limitation, one or more of an HDMI 272, a USB 274, an optical interface 276, and/or a D-subminiature (D-sub) 278, or the like. The interface 270 can be included in, for example, the communication interface 170 of FIG. 1. Additionally or alternately, the interface 270 can include a Mobile High-Definition Link (MHL) interface, a SD card/MMC interface, or an Infrared Data Association (IrDA) standard interface.

The audio module 280, for example, can convert sounds into electrical signals and convert electrical signals into sounds. At least some components of the audio module 280 can be included in, for example, the input/output interface 150 of FIG. 1. The audio module 280 can process sound information inputted or outputted through a speaker 282, a receiver 284, an earphone 286, or the microphone 288. The camera module 291, as a device for capturing still images and videos, can include one or more image sensors (e.g., a front sensor or a rear sensor), a lens, an Image Signal Processor (ISP), or a flash (e.g., an LED or a xenon lamp). The power management module 295, for example, can manage the power of the electronic device 201. According to an embodiment of the present disclosure, the power management module 295 can include a Power Management IC (PMIC), a charger IC, or a battery or fuel gauge, for example. The PMIC can have a wired and/or wireless charging method. The wireless charging method can include, for example, a magnetic resonance method, a magnetic induction method, or an electromagnetic method, and can further include an additional circuit for wireless charging, for example, a coil loop, a resonant circuit, or a rectifier circuit. The battery gauge can measure the remaining capacity of the battery 296, or a voltage, current, or temperature of the battery 296 during charging. The battery 296 can include, for example, a rechargeable battery and/or a solar battery.

The indicator 297 can display a specific state of the electronic device 201 or part thereof (e.g., the processor 210), for example, a booting state, a message state, or a charging state. The motor 298 can convert electrical signals into mechanical vibration and generate a vibration or haptic effect. The electronic device 201 can include a mobile TV supporting device (e.g., a GPU) for processing media data according to standards such as Digital Multimedia Broadcasting (DMB), Digital Video Broadcasting (DVB), or MediaFLOW™ Each of the above-described components of the electronic device can be configured with at least one component and the name of a corresponding component can vary according to the kind of an electronic device. According to an embodiment of the present disclosure, an electronic device (e.g., the electronic device 201) can be configured to include at least one of the above-described components or an additional component, or to not include some of the above-described components. Additionally, some of components in an electronic device are configured as one entity, so that functions of previous corresponding components are performed identically.

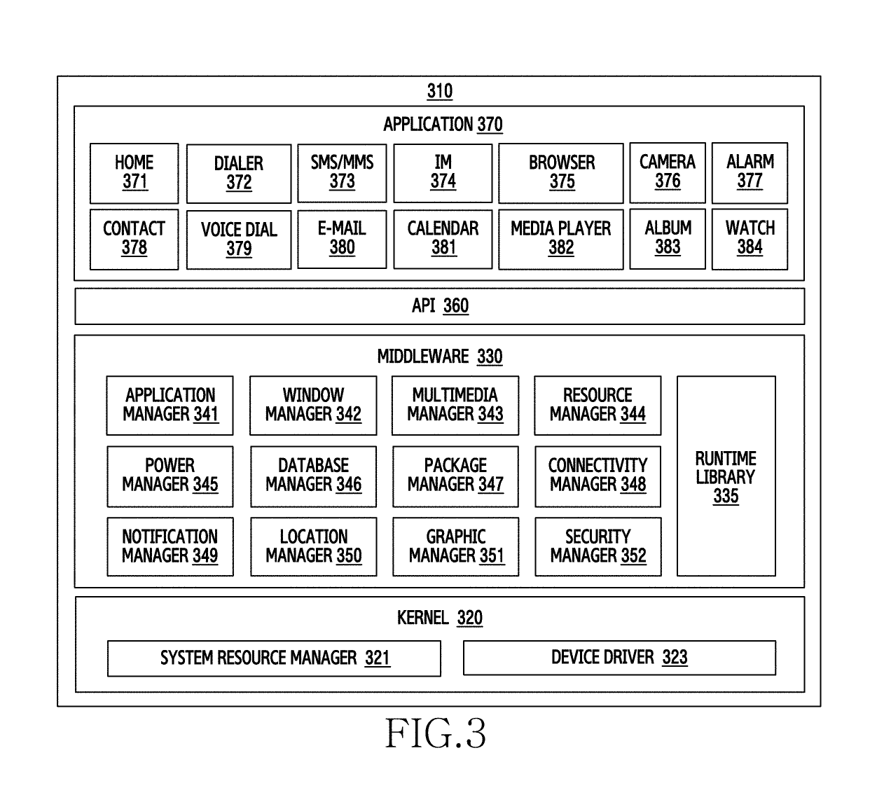

FIG. 3 is a block diagram illustrating a program module according to an embodiment of the present disclosure. A program module 310 (e.g., the program 140) can include an OS for controlling a resource relating to an electronic device (e.g., the electronic device 101) and/or various applications (e.g., the application program 147) running on the OS. The OS can include, for example, Android™, iOS™, Windows™, Symbian™, Tizen™, or Bada™.

Referring to FIG. 3, the program module 310 can include a kernel 320 (e.g., the kernel 141), a middleware 330 (e.g., the middleware 143), an API 360 (e.g., the API 145), and/or an application 370 (e.g., the application program 147). At least part of the program module 310 can be preloaded on an electronic device or can be downloaded from an external electronic device (e.g., the electronic device 102, 104, or the server 106).

The kernel 320 may include, for example, at least one of a system resource manager 321 and/or a device driver 323. The system resource manager 321 can control, allocate, or retrieve a system resource. According to an embodiment, the system resource manager 321 can include a process management unit, a memory management unit, or a file system management unit. The device driver 323 can include, for example, a display driver, a camera driver, a Bluetooth driver, a sharing memory driver, a USB driver, a keypad driver, a WiFi driver, an audio driver, or an Inter-Process Communication (IPC) driver.

The middleware 330, for example, can provide a function commonly required by the application 370, or can provide various functions to the application 370 through the API 360 in order to allow the application 370 to efficiently use a limited system resource inside the electronic device. The middleware 330 includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 can include, for example, a library module used by a complier to add a new function through a programming language while the application 370 is running The runtime library 335 can manage input/output, manage memory, or arithmetic function processing. The application manager 341, for example, can manage the life cycle of the applications 370. The window manager 342 can manage a GUI resource used in a screen. The multimedia manager 343 can recognize a format for playing various media files and encode or decode a media file by using the codec in a corresponding format. The resource manager 344 can manage a source code of the application 3740 or a memory space. The power manager 345 can manage the capacity or power of the battery and provide power information for an operation of the electronic device. The power manager 345 can operate together with a Basic Input/Output System (BIOS). The database manager 346 can create, search, or modify a database used in the application 370. The package manager 347 can manage installation or updating of an application distributed in a package file format.

The connectivity manger 348 can manage, for example, a wireless connection. The notification manager 349 can provide an event, such as incoming messages, appointments, and proximity alerts, to the user. The location manager 350 can manage location information of an electronic device. The graphic manager 351 can manage a graphic effect to be provided to the user or a user interface relating thereto. The security manager 352 can provide, for example, system security or user authentication. The middleware 330 can include a telephony manager for managing a voice or video call function of the electronic device, or a middleware module for combining various functions of the above-described components. The middleware 330 can provide a module specialized for each type of OS. The middleware 330 can dynamically delete part of the existing components or add new components.

The API 360, as a set of API programming functions, can be provided as another configuration according to the OS. For example, Android or iSO can provide one API set for each platform, and Tizen can provide two or more API sets for each platform.

The application 370 can include at least one of a home 371, a dialer 372, an SMS/Multimedia Messaging System (MMS) 373, an Instant Message (IM) 374, a browser 375, a camera 376, an alarm 377, a contact 378, a voice dial 379, an e-mail 380, a calendar 381, a media player 382, an album 383, a clock (watch) 384, or the like. Additionally, or alternatively, though not shown, the application 370 may include various applications, including an application for health care (e.g., measure an exercise amount or blood sugar level), or environmental information (e.g., air pressure, humidity, or temperature information) provision application. The application 370 can include an information exchange application for supporting information exchange between the electronic device and an external electronic device. The information exchange application can include, for example, a notification relay application for relaying specific information to the external device or a device management application for managing the external electronic device. For example, the notification relay application can relay notification information from another application of the electronic device to an external electronic device, or receive and forward notification information from an external electronic device to the user. The device management application, for example, can install, delete, or update a function (e.g., turn-on/turn off of the external electronic device itself (or some components) or display brightness (or resolution) adjustment) of an external electronic device communicating with the electronic device, or an application operating in the external electronic device. The application 370 can include a specified application (e.g., a health care application of a mobile medical device) according to a property of the external electronic device. The application 370 can include an application received from an external electronic device. At least part of the program module 310 can be implemented (e.g., executed) with software, firmware, hardware (e.g., the processor 210), or a combination of at least two of them, and include a module, a program, a routine, a set of instructions, or a process for executing one or more functions.

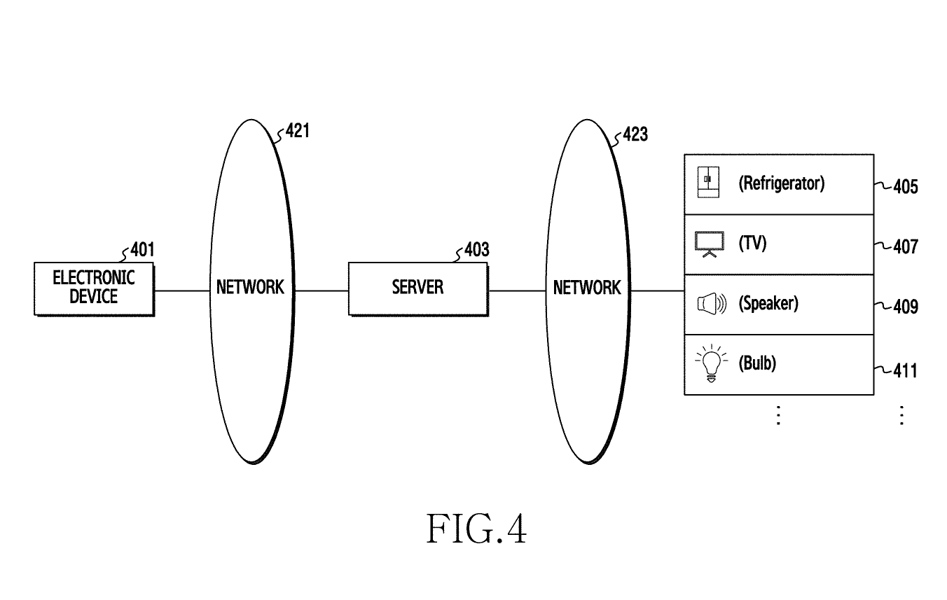

FIG. 4 is a diagram illustrating an electronic device and a server according to various embodiments of the present disclosure.

Referring to FIG. 4, in an embodiment, an electronic device 401 may be a user device which receives from a user, a handwriting input of an object of a specific shape and transmits to a server 403 (via, for example, a network 421), control information for controlling an external electronic device determined based on characteristic information of the handwriting input.

In an embodiment, the determined external electronic device may be at least one of external electronic devices 405, 407, 409 and 411 connected to the server 403 via a network 423.

In an embodiment, an account regarding a control range of the electronic device 401 may be designated in the electronic device 401. In an embodiment, the account designated in the electronic device 401 may register at least one of the external electronic devices 405 through 411, which may be controlled by the electronic device 401. In an embodiment, the electronic device 401 may determine one of the external electronic devices 405, 407, 409 and 411 registered at the account of the electronic device 401, based on the characteristic information of the handwriting input, and transmit control information for controlling the determined electronic device, to the server 403.

In an embodiment, the electronic device 401 may be the electronic device 101 of FIG. 1. For example, the electronic device 401 may include, for example, and without limitation, at least one of, a smart phone, a tablet, a wearable device, a smart TV, a smart refrigerator, a smart washing machine, a smart oven, and/or a robot cleaner, or the like.

In an embodiment, the server 403 may store and manage information of the external electronic devices 405, 407, 409 and 411 connected thereto, transmit the information of the external electronic devices 405, 407, 409 and 411 to the electronic device 401 according to a request of the electronic device 401, and transmit a signal for controlling the external electronic devices 405, 407, 409 and 411, to the external electronic devices 405, 407, 409 and 411 based on the control information received from the electronic device 401.

In an embodiment, the server 403 may be connected to and communicate with the external electronic devices 405, 407, 409 and 411 on a periodic basis, in real time, or in case of an event. In an embodiment, the event may include one of changing status information of one of the external electronic devices 405, 407, 409 and 411, and registering a new external electronic device. For example, changing the status information of the external electronic device may change, if the external electronic device is the TV 407, an ON/OFF status of the TV 407. In an embodiment, by communicating with the external electronic devices 405, 407, 409 and 411, the server 403 may receive the information of the external electronic devices 405, 407, 409 and 411, and store and manage the received information.

In an embodiment, the electronic device 401 may transmit to the server 403, a signal for requesting the information about at least one of the external electronic devices 405, 407, 409 and 411 or a signal for controlling at least one of the external electronic devices 405, 407, 409 and 411.

In an embodiment, the information about the external electronic devices 405, 407, 409 and 411, which is requested by the electronic device 401 from the server 403, may include at least one of a list of the external electronic devices 405, 407, 409 and 411 connected to the server 403, the status information of the external electronic devices 405, 407, 409 and 411 connected to the server 403, and a list of external electronic devices controllable by the electronic device 401.

In an embodiment, by receiving a user input which selects an object indicating at least one of the external electronic devices 405, 407, 409 and 411 connected to the server 403, in the list, or a user input which inputs a search word corresponding to at least one external electronic device, the electronic device 401 may determine at least one of the external electronic devices 405, 407, 409 and 411 connected to the server 403. In an embodiment, the electronic device 401 may request information of the at least one external electronic device determined, from the server 403.

In an embodiment, the server 403 may allocate at least one storage space to one of the external electronic devices 405, 407, 409 and 411 connected to and communicating with the server 403 on a periodic basis, in real time, or in case of an event. In an embodiment, the server 403 may store connection information and the status information, which are received from the external electronic devices 405, 407, 409 and 411, in the allocated storage space, and provide the stored information to the electronic device 401 according to a request of the electronic device 401.

For example, the electronic device 401 may access the server 403 and receive information about one of the external electronic devices 405, 407, 409 and 411, without having to directly accessing one of the external electronic devices 405, 407, 409 and 411 to control. As another example, the electronic device 401 may transmit a control command for the external electronic device (one of the external electronic devices 405, 407, 409 and 411), to the external electronic device (one of the external electronic devices 405, 407, 409 and 411) via the server 403.

In an embodiment, the server 403 may be an Internet of things (IoT) cloud server, and the external electronic devices 405, 407, 409 and 411 may be electronic devices subscribed to an IoT cloud system.

In an embodiment, the external electronic devices 405, 407, 409 and 411 may have communication functionality, be located within a specified area, and be connected to and communicate with the server 403 on a periodic basis, in real time, or in case of an event. For example, the external electronic devices 405, 407, 409 and 411 may include, but not limited to, the refrigerator 405, the TV 407, the speaker 409, and the bulb 411.

In an embodiment, networks 421 and 423 are a kind of the network 162 of FIG. 1 and may be telecommunications networks. For example, the network 421 may be a cellular communication network, and the network 423 may be a home network deployed between various electronic devices in home.

In an embodiment, although not depicted, the electronic device 401 may be directly connected with the external electronic devices 405, 407, 409 and 411, without the server 403. In an embodiment, the electronic device 401 may communicate with the external electronic devices 405, 407, 409 and 411 on a periodic basis, in real time, or in case of an event, determine one or more of the external electronic devices 405, 407, 409 and 411 and their control information according to a user's handwriting input, and directly transmit the determined control information to the determined devices.

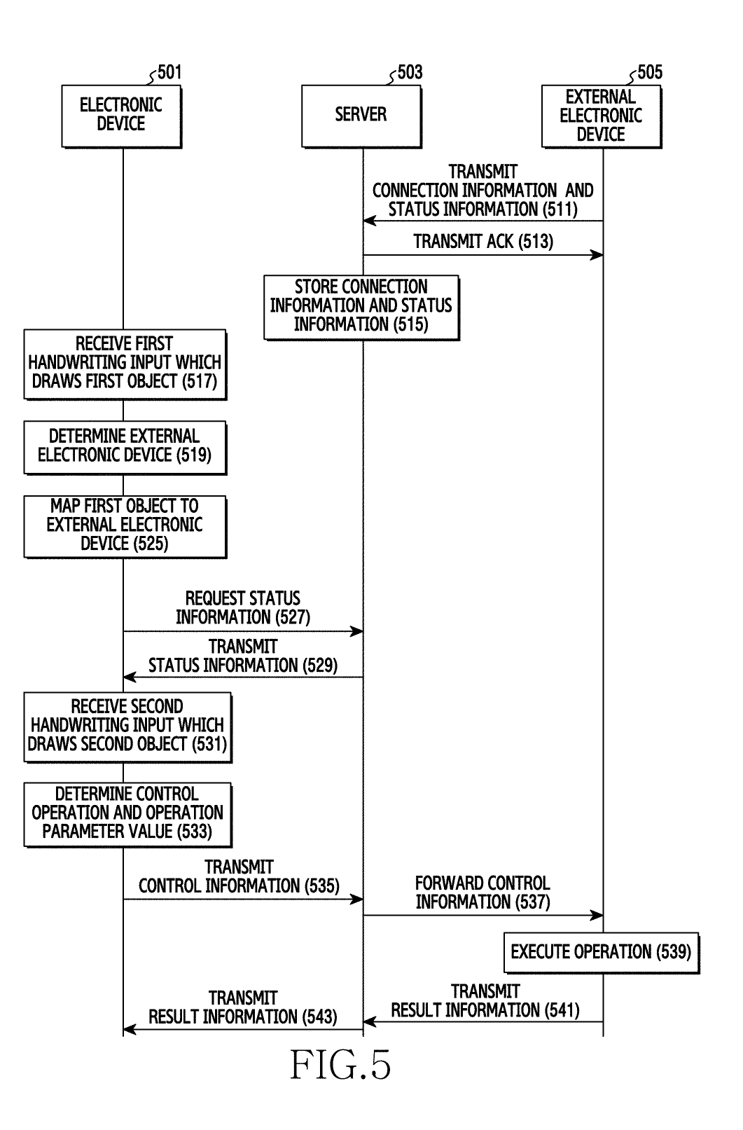

FIG. 5 is a diagram illustrating signal flows between an electronic device, a server, and an external electronic device according to various embodiments of the present disclosure.

In an embodiment, an external electronic device 505 may be one of external electronic devices (e.g., the external electronic devices 405, 407, 409 and 411 of FIG. 4), be connected to a server 503, and communicate with the server 503 over a network (e.g., the network 423 of FIG. 4) on a periodic basis, in real time, or in case of an event. For example, the external electronic device 505 may, for example, be the refrigerator 405.

In operation 511, the external electronic device 505 may transmit connection information and status information to the server 503 connected over the network.

According to an embodiment, the connection information may include configuration information required for the external electronic device 505 to access the server 503. For example, the connection information may be Internet protocol (IP) information of the external electronic device 505.

According to an embodiment, the connection information may include information indicative of a connection status (e.g., a network status) between the external electronic device 505 and the server 503. For example, if the network (e.g., the network 423 of FIG. 4) is WiFi, the connection information may be WiFi signal strength information.

In an embodiment, the status information may include information indicative of a current status of the external electronic device 505. For example, if the external electronic device 505 is an air conditioner and is presently turned on, the status information may include a current temperature, a set temperature, a time elapsed after the power-on, or reservation end information when reservation end is set, which are displayed at the air conditioner.

Upon receiving the connection information and the status information from the external electronic device 505, the server 503 may transmit ACK information indicating the received connection information and status information, to the external electronic device 505 in operation 513.

In operation 515, the server 503 may store the connection information and the status information received from the external electronic device 505. The server 503 may store the connection information and the status information in its internal database or external database. In an embodiment, operations 511, 513, and 515 may be carried on a periodic basis at specific time intervals, in real time, or in case of an event.

In operation 517, an electronic device 501 (e.g., the processor 120) may receive a first handwriting input which draws a first object, through a display (e.g., the display 160). For example, the electronic device 501 may by the electronic device 401 of FIG. 4. The electronic device 501 may receive the first handwriting input from a user or according to execution of a program which is stored in its storage unit (e.g., the memory 230 of FIG. 2) and configured to display the first object on the display 160.

According to an embodiment, the first object may be displayed on the display 160 according to a combination of one or more basic geometrical elements (points, lines). For example, the first object may be a figure, a character, a number, or a combination of them. According to another embodiment, the combination of one or more geometrical elements may include relatively positional relationships (e.g., inclusion, parallel, symmetry, or overlap) of one or more geometric elements.

According to an embodiment, the first object displayed on the display 160 may move according to a user input.

According to an embodiment, the electronic device 501 may receive the first handwriting input through the display 160, and the display 160 may be a touch screen.

According to an embodiment, the electronic device 501 may receive the first handwriting input by detecting touch on the touch screen with a user's body part (e.g., a finger). According to another embodiment, the electronic device 501 may receive the first handwriting input through an input device such as a digital pen.

In operation 519, the electronic device 501 may determine an external electronic device. According to an embodiment, the electronic device 501 may determine the external electronic device to control, based on characteristic information of the first handwriting input. According to an embodiment, the external electronic device to control may be the external electronic device 505. For example, if receiving the first object which simplifies a rectangle and two straight lines inside the rectangle, the electronic device 501 may determine the external electronic device 505 to control, as a refrigerator (e.g., the refrigerator 405).

According to an embodiment, if not specifying one external electronic device 505 to control based on the characteristic information of the first handwriting input, the electronic device 501 may determine one external electronic device 505 to control, based on a user's additional input. For example, if the first object which simplifies the shape of the refrigerator and the external electronic devices 405, 407, 409 and 411 include two or more identical refrigerators, the electronic device 501 may provide a list of candidates for the two or more external electronic devices. As another example, if receiving the first object which may be part of washer and vacuum cleaner shapes, the electronic device 501 may provide a list of candidates for the external electronic devices including the washer and the vacuum cleaner. According to an embodiment, the electronic device 501 may determine one external electronic device 505 to control based on the user's input for the displayed list. For example, the electronic device 501 may provide information about the candidate list to the user through the display 160 or a speaker (e.g., the speaker 282), and determine the external electronic device 505 based on a user's input (e.g., a touch or a voice).

According to an embodiment, based on the characteristic information (e.g., shape information) of the first handwriting input, the electronic device 501 may determine one external electronic device 505 to control, among external electronic devices registered in the designated account of the electronic device 501.

According to an embodiment, the electronic device 501 may determine the external electronic device 505 to control, based on its use history information or use frequency information. For example, if determining, based on the use history information or the use frequency information of the electronic device 501, that the TV 407 has been controlled most frequently, the electronic device 501 may determine the external electronic device 505 to control, as the TV 407 based on the characteristic information (e.g., shape information) of the first handwriting input. In so doing, the electronic device 501 may determine the external electronic device 505 to control, as the TV 407, according to whether the object displayed based on the first handwriting input simplifies a predetermined mark indicative of the highest frequency.

In operation 525, the electronic device 501 may map the first object to the external electronic device 505. The external electronic device 505 may be the external electronic device determined in operation 519.

According to an embodiment, mapping the first object to the external electronic device 505 indicates mapping the first object to the external electronic device 505 to control the external electronic device 505 using the user input received while the first object is displayed. For example, mapping the first object which simplifies the shape of the refrigerator 405, to the refrigerator 405 indicates mapping the first object to the refrigerator 405 to control the refrigerator 405 using a user's additional input received while the first object is displayed on the display 160.

According to an embodiment, operation 519 for determining the external electronic device 505 may determine the external electronic device 505 to control, based on the first handwriting input which draws the first object. Operation 525 for mapping the first object to the external electronic device 505 may entering a mode for controlling the determined external electronic device 505, according to the user input associated with the displayed first object, such that the user may control the determined external electronic device 505 using the displayed first object.

In operation 527, the electronic device 501 may request the status information from the server 503. According to an embodiment, the electronic device 501 may request the status information of the external electronic device 505 to control, from the server 503.

In operation 529, the server 503 may transmit the status information of the external electronic device 505 to the electronic device 501. For example, the server 503 may transmit current temperature information or a memo, if any, of the external electronic device 505 (e.g., the refrigerator) to the electronic device 501.

In operation 531, the electronic device 501 may receive a second handwriting input which draws a second object through the display 160. According to an embodiment, the electronic device 501 may receive the second handwriting input which draws the second object while the first object mapped to the external electronic device 505 is displayed.

In operation 533, the electronic device 501 may determine a control operation and an operation parameter value. According to an embodiment, the electronic device 501 may determine the control operation and the operation parameter value, based on characteristic information of the second handwriting input. According to an embodiment, the control operation may indicate an operation to be performed by the external electronic device 505.

In operation 535, the electronic device 501 may transmit control information to the server 503. According to an embodiment, the control information may include information about the external electronic device 505 to control, and information about the control operation and the operation parameter value.

In operation 537, based on the control information, the server 503 may forward a control command including the information of the control operation and the operation parameter value, to the external electronic device 505 to control.

In operation 539, the external electronic device 505 may perform (execute) the control operation, based on the received control command According to an embodiment, the external electronic device 505 may conduct the control operation by considering the information of the operation parameter value. For example, if the external electronic device 505 is a refrigerator, the external electronic device 505 may lower the set temperature by two degrees according to the received control command. For example, if the external electronic device 505 is a TV, the external electronic device 505 may increase a current volume by three levels according to the received control command

In operation 541, the external electronic device 505 may transmit result information to the server 503. In an embodiment, the result information indicates information about the result of operation 539 of the external electronic device 505.

In operation 543, the server 503 may transmit the result information received from the external electronic device 505, to the electronic device 501. Although not depicted, the electronic device 501 may display the received result information on the display.

As such, the electronic device 501 may control the external electronic device 505, wherein the external electronic device 505 performs a specified operation based on the handwriting input which draws the object. While the electronic device 501 controls the external electronic device 505 through the server 503, the electronic device 501 may control the external electronic device 505 by directly accessing the external electronic device 505, without passing through the server 503 according to another embodiment.

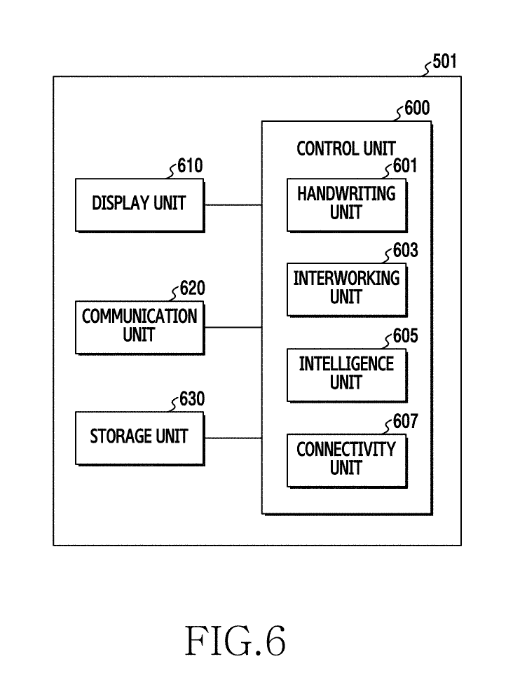

FIG. 6 is a block diagram illustrating an electronic device according to various embodiments of the present disclosure. According to an embodiment, the electronic device 501 may be the electronic device 401 of FIG. 4. The electronic device 501 may include a display unit (e.g., including a display) 610, a communication unit (e.g., including communication circuitry) 620, a storage unit (e.g., including a memory) 630, or a control unit (a processor) (e.g., including processing circuitry) 600.

The display unit 610 may be electrically connected to the control unit 600, and display a user interface for receiving a user's handwriting input, user input data such as a handwriting input, or a notification message from the control unit 600. For example, the display 610 may be the display 160. In an embodiment, the display unit 610 may receive data from the user. For example, the display unit 610 may be a touchscreen display.

The communication unit 620 may include various communication circuitry and be electrically connected to the control unit 600, and transmit control information for controlling the external electronic device 505 (e.g., a TV) to the server 503 based on the received user's handwriting input. For example, the communication unit 620 may be the communication module 220 of FIG. 2.

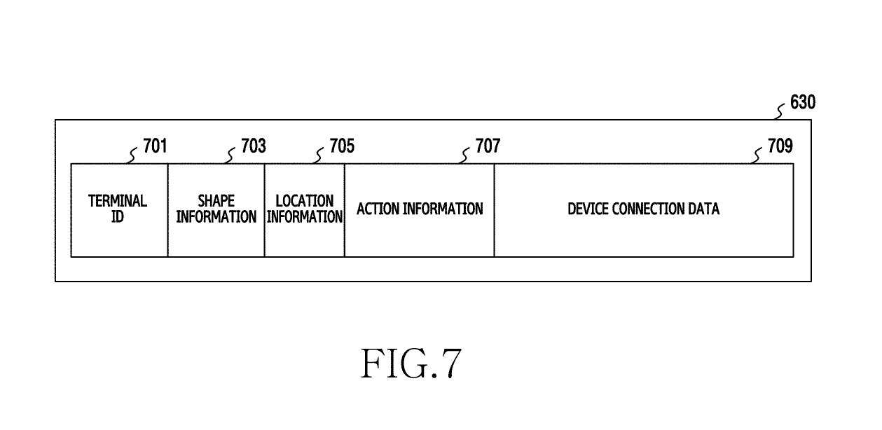

The storage unit 630 may be electrically connected to the control unit 600, and store information for controlling the external electronic device 505 using the user's handwriting input. In an embodiment, the storage unit 630 may be the memory 130 of FIG. 1 or the memory 230 of FIG. 2. The storage unit 630 shall be described in further detail in FIG. 7.

At least one or more control units 600 may be included in the electronic device 501, and perform a designated function of the electronic device 501. In an embodiment, the control unit 600 may be configured to determine a shape of a first object displayed on the display 160 according to the received user handwriting input, to select the external electronic device 505 based on the first object shape, and to establish wireless communication with the external electronic device 505 using the communication unit 620. For example, the control unit 600 may establish the wireless communication with the external electronic device 505 through the server 403, and establish the wireless communication directly with the external electronic device 505 without the server 403. In an embodiment, the control unit 600 may include a handwriting unit (e.g., including processing circuitry and/or program elements) 601, an interworking unit (e.g., including processing circuitry and/or program elements) 603, an intelligence unit (e.g., including processing circuitry and/or program elements) 605, and a connectivity unit (e.g., including processing circuitry and/or program elements) 607. For example, the control unit 600 may be the processor 120 of FIG. 1 or the processor 210 of FIG. 2.

The handwriting unit 601 may include various processing circuitry and/or program elements and process and display the user's handwriting input. According to an embodiment, the handwriting unit 601 may receive the user's handwriting input by detecting touch on a touchscreen using a user's body part (e.g., a finger). According to another embodiment, the handwriting unit 601 may receive the handwriting input through an input device such as a digital pen.

According to an embodiment, the handwriting unit 601 may determine characteristic information of the handwriting input. The characteristic information of the handwriting input may include at least one of a shape of an object displayed on the display 160, a location of the object, a writing pressure of the object input, a writing speed of the object input, a pen tilt of the object input, a direction of the object input, a thickness of a line of the object, and a stroke length of the object.

Using the characteristic information of the handwriting input received from the handwriting unit 601, the interworking unit 603 may map the object displayed on the display 160, to the external electronic device 505, or control the external electronic device 505 mapped to the object displayed on the display 160. According to an embodiment, mapping the external electronic device 505 to the object may indicate mapping a first object to the external electronic device 505, in order to control the external electronic device 505 using the user input which is input while the object is displayed.

According to an embodiment, the interworking unit 603 may include various processing circuitry and/or program elements and store the mapping information and the control information in the storage unit 630. According to another embodiment, the interworking unit 603 may display control result information through the display 160.

The intelligence unit 605 may include various processing circuitry and/or program elements and receive from an external server, a notion or a word associated with the object displayed on the display 160, using the characteristic information of the handwriting input received from the handwriting unit 601.

According to an embodiment, the intelligence unit 605 may include various processing circuitry and/or program elements and extract a word associated with the object shape displayed on the display 160 according to the user's handwriting input, and enumerate the associate word by applying ontology to the extracted word. For example, if the object displayed on the display 160 includes a rectangle and a circle in the rectangle according to the user's handwriting input, the intelligence unit 605 may search images of electronic devices belonging to a home appliances category and thus extract a word “washer” associated with the object shape displayed on the display 160.

According to an embodiment, based on the received notion or word, the interworking unit 603 may determine an electronic device to be mapped to the object displayed on the display 160, or determine an operation to be conducted by the external electronic device 505 mapped to the object displayed on the display 160. For example, if the word associated with the object shape displayed on the display 160 is “washer”, the intelligence unit 605 may map the washer, which is one of the external electronic devices 405 through 411 of FIG. 4, to the object displayed on the display 160.

The connectivity unit 607 may include various processing circuitry and/or program elements and receive information of the external electronic device connectable, from the server 503 and transmit the received information to the intelligence unit 605 or the interworking unit 603. According to an embodiment, the connectivity unit 607 may transmit the operation information determined at the intelligence unit 605, to the interworking unit 603, or transmit the control result information of the external electronic device 505 to the interworking unit 603.

It is noted that the handwriting unit 601, the interworking unit 603, the intelligence unit 605, and the connectivity unit 607 are distinguished to ease the understanding, the control unit 600 may be configured to carry out all the operations of those units.

FIG. 7 is a diagram illustrating information stored in a storage unit of an electronic device according to various embodiments of the present disclosure.

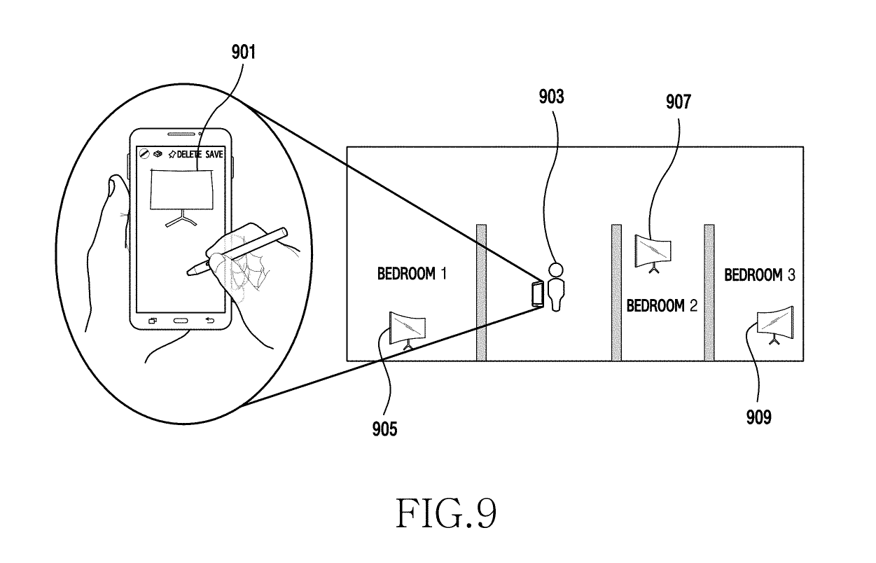

FIG. 9 is a diagram illustrating location information of external electronic devices 905, 907, 909, which is one of the information of FIG. 7.

According to an embodiment, the storage unit 630 of the electronic device 501 may include a terminal ID 701, shape information 703, location information 705, action information 707, and device connection data 709.

According to an embodiment, the electronic device 501 may receive and store the information (e.g., the shape information, the location information, or the action information) from the server 403. According to an embodiment, before receiving a handwriting input from the user, the electronic device 501 may receive and store the information from the server 403. According to another embodiment, the electronic device 501 may receive the handwriting input from the user, request at least one of the information from the server 503, receive the requested information, and store the received information in the storage unit 630.

The terminal ID 701 may include unique identification information of at least one (e.g., the external electronic device 505) of the external electronic devices. In an embodiment, the electronic device 501 may request status information from the server 503, or transmit information of the terminal ID 701 to the server 503 when transmitting the control information. For example, the terminal ID 701 may be media access control (MAC) address information or international mobile equipment identity (IMEI) code of the external electronic device (e.g., the external electronic device 505).

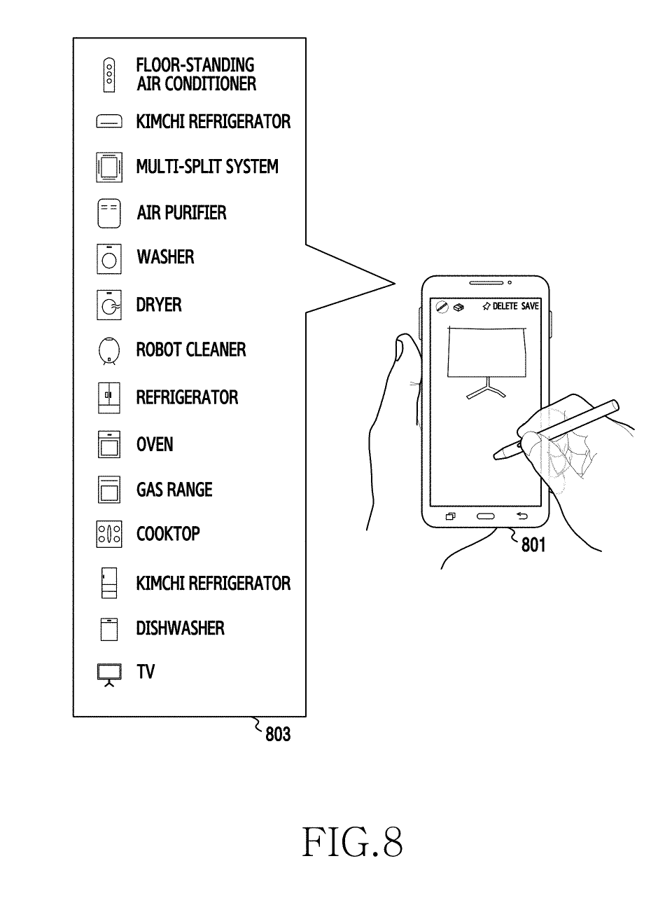

The shape information 703 may be reference information for determining the external electronic device 505 to control using the user's handwriting input. In an embodiment, the shape information 703 may include one or more external electronic devices 505, and one or more shapes corresponding to the external electronic devices 505. The shape information 703 shall be explained in greater detail below in FIG. 8.

Referring to FIG. 9, the location information 705 may include locations of the one or more external electronic devices. For example, if external electronic devices connected to the server are three TVs 905, 907, and 909 in FIG. 9, the location information 705 may include location information of the three TVs on a map. For example, the location information 705 may include latitude information and longitude information of the locations of the three TVs.

According to an embodiment, the electronic device 501 may determine its current location using GPS information acquired through its GPS sensor or triangulation based on a signal strength, and determine distance relations between the electronic device 501 and the external electronic devices using the determined current location of the electronic device 501 and the location information 705. For example, based on a current location 903 of the electronic device and the location information of the three TVs 905, 907, and 909 in FIG. 9, the electronic device 501 may determine that the TV 907 in a second bedroom is closest to its current location 903 and the TV 909 in a third bedroom is the farthest.

According to an embodiment, the electronic device 501 may determine its current direction information, and determine a relative positional relation using the determined current direction information, the current location information, and the location information 705. For example, based on the current direction information of the electronic device 501 and the current location 903 of the electronic device in FIG. 9, the electronic device 501 may determine that the TV 909 in the third bedroom is located on the right from the current direction and the TV 905 in a first bedroom is located on the left from the current direction.

The action information 707 may be reference information for the electronic device 501 to determine which operation the external electronic device 505 is controlled to conduct, using the user's handwriting input. According to an embodiment, the action information 707 may include operation information and one or more shapes corresponding to the operation information.

In an embodiment, the operation information of the action information 707 may include information about one or more operations executable by the external electronic device 505, and the electronic device 501 may receive the operation information of the action information 707 from the server 503 or the external electronic device 505 to control. In an embodiment, the operation information may vary depending on the external electronic device 505. For example, if the external electronic device 505 is an air conditioner, the operation information may include temperature control or mode control. If the external electronic device 505 is the TV 407, the operation information may include channel control, volume control, or mute.

According to another embodiment, the shape in the action information 707 may be associated with the corresponding operation information. For example, an up arrow shape may correspond to an operation which increases a numerical value (e.g., a volume, a TV channel number, or an air conditioning temperature).

According to yet another embodiment, identical shapes having different drawing orders may be distinguished from each other in the action information 707. That is, identical shapes having different drawing orders may correspond to different operation information. For example, a shape displayed by drawing a circle and then an oblique line crossing the circle may correspond to an OFF operation of the electronic device, and a shape displayed by drawing an oblique line and then a circle over the oblique line may correspond to an ON operation of the electronic device.

According to still another embodiment, the correspondence between the shape and the operation information of the action information 707 may vary according to the determined external electronic device 505. For example, if the electronic device to control is a TV, the up arrow shape may correspond to the volume-up. If the electronic device to control is an air conditioner, the up arrow shape may correspond to the rise of the setting temperature. Hence, one shape (e.g., the up arrow) may control a plurality of electronic devices, and one shape may control only one electronic device.

The device connection data 709 may include information about the external electronic devices controllable, or information about an external electronic device (e.g., the external electronic device 505) previously controlled by the electronic device 501. According to an embodiment, the device connection data 709 may include specifications information or manual information of the external electronic devices controllable by the electronic device 501. According to another embodiment, the device connection data 709 may include control records of a particular external electronic device (e.g., the external electronic device 505). For example, the device connection data 709 may include use history information of controlling the external electronic device (e.g., the external electronic device 505) by inputting a handwriting, and use frequency information of controlling the external electronic device. According to yet another embodiment, the device connection data 709 may include information for the electronic device 501 to control at least one (e.g., the external electronic device 505) of the external electronic devices 405 through 411 without the server 503. For example, the device connection data 709 may include information (e.g., MAC address or IP address) of the external electronic device, for directly communicating with and accessing at least one of the external electronic devices 405 through 411.

Although not depicted, the storage unit 630 may further store a program for converting a user's voice input to a text, or keyword information for controlling the external electronic device 505.

FIG. 8 is a diagram illustrating shape information stored in a storage unit of an electronic device according to various embodiments of the present disclosure.

According to an embodiment, an electronic device 801 may receive from a user, a handwriting input which draws an object in a specific shape. For example, the electronic device 801 may be the electronic device 401 of FIG. 4.

According to an embodiment, shapes 803 of the shape information 703 may simplify typical shapes of the external electronic devices controllable by the electronic device 801. For example, the shapes 803 of the shape information 703 may include one or more geometrical elements (points or lines), and be determined by a combination of one or more geometrical elements.

According to an embodiment, the combination of one or more geometrical elements may include a relative positional relation (e.g., inclusion, parallel, symmetry, or overlap) of the one or more geometrical elements. For example, the shape information 903 may include information indicating that a simplified shape (e.g., a rectangle whose a bottom side is longer than a left side or a right side, and a segment line in parallel with and shorter than the bottom side in the rectangle) of a typical image of a wall-mounted air conditioner corresponds to the wall-mounted air conditioner. For example, the shape information 903 may include information indicating that a simplified shape (e.g., a quadrangle and an upside-down Y below a bottom side of the quadrangle) a typical image of a TV corresponds to the TV 407.

According to an embodiment, the shape may be learned individually. That is, the electronic device 801 may modify a shape corresponding to a specified external electronic device, based on a user's separate input. For example, the electronic device 801 may determine the shape corresponding to the TV 407, as a shape which includes a triangle and an upside-down Y below the triangle, rather than the quadrangle and the upside-down Y below the quadrangle, and thus update the shape information 703.

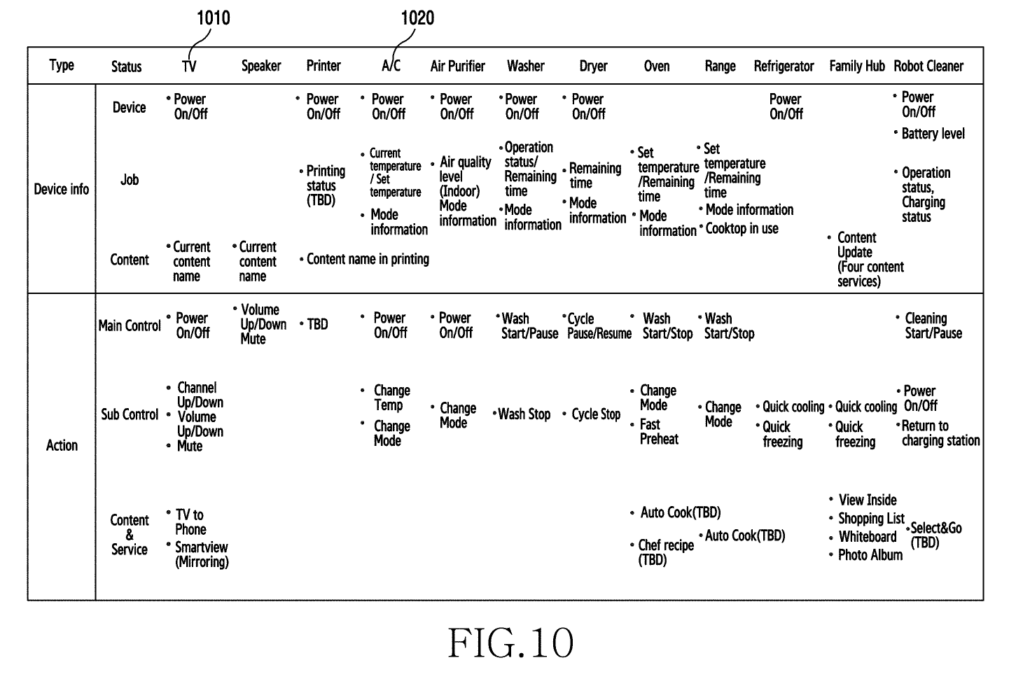

FIG. 10 is a diagram illustrating operation information of action information stored in a storage unit of an electronic device according to various embodiments of the present disclosure.

According to an embodiment, operation information of action information stored in a storage unit (e.g., the storage unit 630) of an electronic device (e.g., the electronic device 501) may vary according to the external electronic device 505 to control. For example, if the external electronic device 505 is determined, the operation information for controlling the determined external electronic device 505 may be determined. For example, if the external electronic device 505 to control is a TV 1010, a control unit (e.g., the control unit 600 of FIG. 6) may identify that the operation information includes items such as power ON/OFF, channel change, volume up/down, or mute. For example, if the external electronic device 505 to control is an A/C 1020, the control unit 600 may identify that the operation information includes items such as power ON/OFF, temperature change, or mode change.

According to an embodiment, actions for controlling the determined external electronic device 505 may be classified into a main control action, a sub control action, and a content & service, based on at least one of importance, use frequency, and content provision of the action. For example, if the external electronic device 505 to control is determined to the TV 1010, the power ON/OFF may be classified to the main control action, and the channel control, the volume control, and the mute may be classified to the sub control actions. For example, if the external electronic device 505 to control is determined to the TV 1010, Smartview (e.g., screen mirroring) may be classified to the content & service.

According to another embodiment, if the external electronic device 505 to control is determined, items to be contained in device information or status information of the determined external electronic device 505 may be determined. For example, if the external electronic device 505 to control is determined to the A/C 1020, the control unit 600 may identify that the device information includes items indicating power ON/OFF information, a current temperature, a set temperature, and mode information.

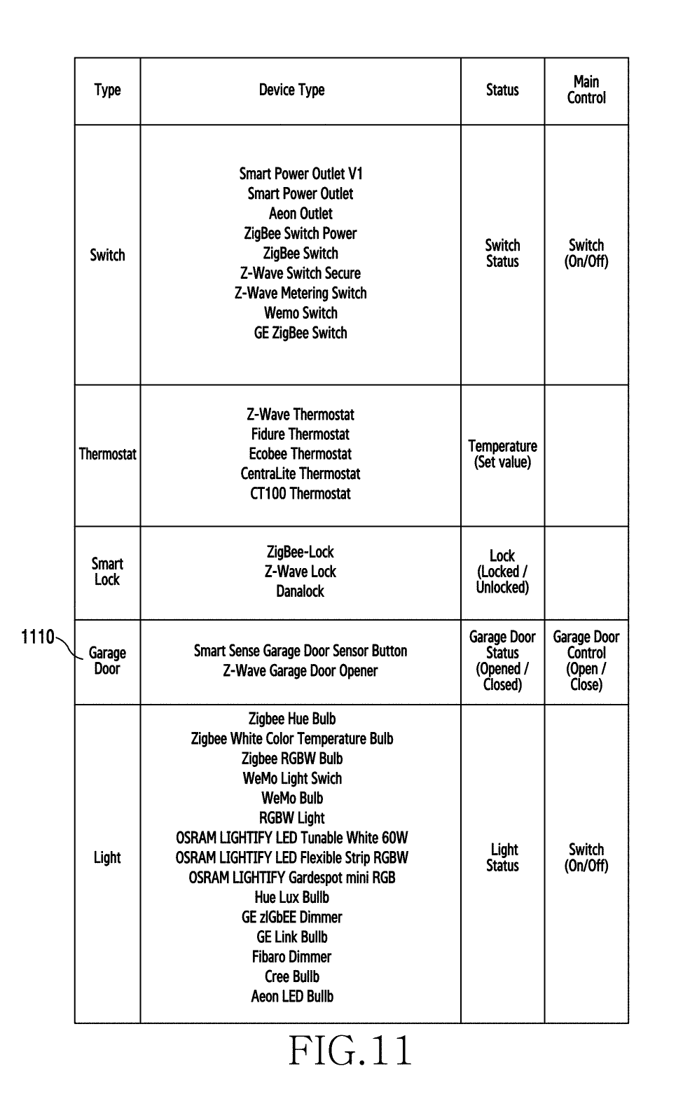

FIG. 11 is a diagram illustrating operation information of action information stored in a storage unit of an electronic device according to various embodiments of the present disclosure.

According to an embodiment, similarly to FIG. 10, operation information of action information stored in a storage unit (e.g., the storage unit 630) of an electronic device (e.g., the electronic device 501) may vary according to the external electronic device 505 to control. For example, if the external electronic device 505 is determined to a garage door 1110, the electronic device may identify garage door control (open/close) as the operation information of the external electronic device 505 to control.

According to another embodiment, if the external electronic device 505 to control is determined, items to be contained in the status of the determined external electronic device 505 may be determined. For example, if the external electronic device 505 to control is determined to the garage door 1110, the electronic device may identify that the status of the external electronic device 505 to control includes an item indicating whether the garage door is opened or closed.

According to various example embodiments, an electronic device (e.g., the electronic device 501 of FIG. 5) may include a housing, a touchscreen display (e.g., the display 160 of FIG. 1) exposed through part of the housing, a wireless communication circuit (e.g., the communication interface 170 of FIG. 1 or the communication module 220 of FIG. 2), a processor (e.g., the control unit 600 of FIG. 6 of the processor 120 of FIG. 1) disposed inside the housing and electrically coupled with the display and the wireless communication circuit, and a memory (e.g., the memory 130 of FIG. 1) disposed inside the housing and electrically coupled with the processor. The memory may store instructions which, when executed by the processor, cause the electronic device to provide a user interface for receiving a user handwriting input, to receive a first handwriting input of a first object through the display, to determine a shape of the first object, to select an external electronic device to control based on the shape of the first object, and to establish wireless communication with the external electronic device, through the wireless communication circuit.

According to various example embodiments, the memory may further store instructions which, when executed by the processor, cause the electronic device to receive a second handwriting input of a second object through the display, and to determine a function to be executed by the external electronic device to control and a parameter value of the function, based on characteristic information of the second handwriting input.

According to various example embodiments, the electronic device may further include a digitizer disposed inside the housing. The processor may be configured to receive the first handwriting input and/or the second handwriting input, using the digitizer and a stylus pen configured to input the handwriting inputs to the digitizer.

According to various example embodiments, the characteristic information of the second handwriting input of the second object may include at least one of an intensity of the second handwriting input, a direction of the second handwriting input, a shape of the second object, and a position of the second object.

According to various example embodiments, the memory may store instructions which, when executed by the processor, cause the electronic device to extract one or more shapes including one or more elements of the first object, from a plurality of shapes in the memory, to determine one or more external electronic devices corresponding to the one or more shapes extracted, and to select one of the one or more external electronic devices, as the external electronic device to control.

According to various embodiments, the memory may store instructions which, when executed by the processor, cause the electronic device to receive an additional user input in response to the one or more external electronic devices determined, and to select one of the one or more external electronic devices, as the external electronic device to control, based on the received additional user input.

According to various example embodiments, the memory may further store an instruction which, when executed by the processor, causes the electronic device to provide a guide regarding the one or more external electronic devices, in response to the one or more external electronic devices determined, and the additional user input may be related to the provided guide.

According to various example embodiments, the memory further store an instruction which, when executed by the processor, causes the electronic device to provide the guide regarding the one or more external electronic devices, by displaying the first object on the display and displaying on the display, elements for completing the first object as one of the one or more shapes determined.

According to various example embodiments, the memory may store instructions which, when executed by the processor, cause the electronic device to determine one or more shapes corresponding to the first object among a plurality of shapes in the memory, based on geometrical characteristics of one or more elements of the first object, a proportion to a display size, and relative positional relationships between the one or more elements, to determine one or more external electronic devices corresponding to the one or more shapes determined, and to select one of the one or more external electronic devices, as the external electronic device to control.

According to various example embodiments, the memory may store instructions which, when executed by the processor, cause the electronic device, if the one or more shapes extracted are identical, to determine one of the one or more shapes extracted, based on at least one of location information, direction information, distance information, use frequency information, and use history information, and to select an external electronic device corresponding to the one shape, as the external electronic device to control.

According to various example embodiments, the external electronic device to control may include at least one of a first external electronic device and a second external electronic device, and the memory may store instructions which, when executed by the processor, cause the electronic device to determine a function to be executed by at least one of the first external electronic device and the second external electronic device, and a parameter value of the function.

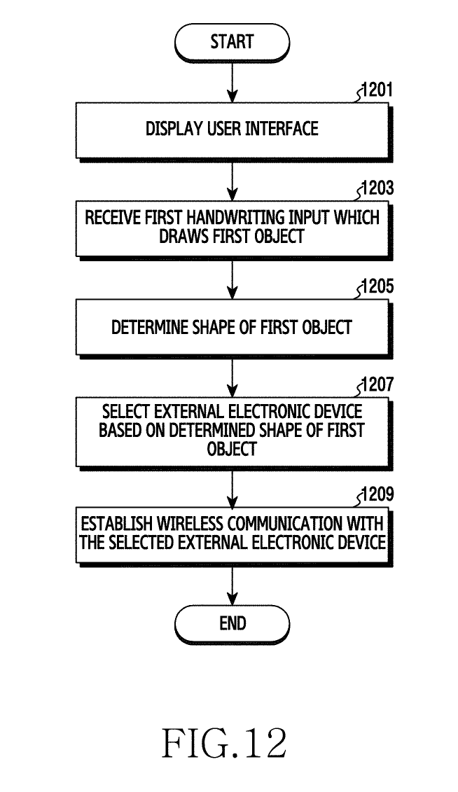

FIG. 12 is a flowchart illustrating operations of an electronic device for controlling an external electronic device using a user's handwriting input according to various embodiments of the present disclosure.

In operation 1201, a control unit (e.g., the control unit 600 of FIG. 6) of an electronic device (e.g., the electronic device 501) may provide and display a user interface for receiving a handwriting input.

According to an embodiment, as executing a particular application, the control unit 600 may provide the user interface for receiving a handwriting input by entering a particular mode for receiving a handwriting input. For example, the particular application may be a memo application.

According to another embodiment, the control unit 600 may provide the user interface for receiving a handwriting input by using a user input as a triggering event. For example, if executing a memo application and detecting a user input which selects a particular button or icon, the control unit 600 may provide the user interface for receiving a handwriting input. For example, if a pen detachable from the electronic device is separated and a user input is detected on the display which is turned off, the control unit 600 may provide the user interface for receiving a handwriting input.

In operation 1203, the control unit 600 may receive a first handwriting input which draws a first object.

According to an embodiment, the first object may be displayed on the display 160 with a combination of one or more basic geometrical elements (points, lines).

According to another embodiment, the control unit 600 may receive the first handwriting input through an input device such as a digital pen, load at least one of use history information and use frequency information which are stored in a storage (e.g., the storage 630 of FIG. 6), and display an object of the use history information or the use frequency information on the display 160.

According to yet another embodiment, the use history information or the use frequency information includes information about the particular external electronic device 505 mapped to the object, but the control unit 600 may map the first object to a device which is different from the particular external electronic device 505.

In operation 1205, the control unit 600 may determine a shape of the first object.

According to an embodiment, the control unit 600 may determine the shape of the first object, based on coordinate information of points of the first object.

In an embodiment, the determined shape of the first object may include information about one or more elements of the first object. For example, the control unit 600 may set the display 160 of the electronic device in a two-dimensional coordinate plane, obtain coordinate information of the points of the first object on the display 160, and determine based on the coordinate information that the first object displayed on the display 160 includes a rectangle and two segment lines.

In an embodiment, the determined shape of the first object may include relative positional relationship information of one or more elements of the first object. For example, the relative positional relationship information may indicate that two segment lines of the first object displayed on the display 160 have two different points of a bottom side of the rectangle, as their end points, and are symmetric based on a vertical virtual line crossing the center of the rectangle.

In operation 1207, the control unit 600 may select the external electronic device 505, based on the determined shape of the first object.

In an embodiment, the control unit 600 may select the external electronic device 505 to control, by comparing the determined shape of the first object with the shape 803 of the shape information 703 stored in the storage unit 630. For example, if the determined first object includes a rectangle and two segment lines and has the above-stated relative positional relation, the control unit 600 may determine, among shapes of the shape information 703, a shape which includes a rectangle and two segment lines and meets the relative positional relation of the rectangle and the two segment lines, and determine the external electronic device 505 corresponding to the determined shape.

Although not depicted, the control unit 600 may select the external electronic device 505, based on the determined shape of the first object, and relative sizes, positions, or input orders of the one or more elements of the first object.

In operation 1209, the control unit 600 may establish wireless communication with the selected external electronic device 505. According to an embodiment, to control the selected external electronic device 505, the control unit 600 may establish device to device communication with the selected external electronic device 505 and establish wireless communication with the server 503 to transmit to the server 503, control information for controlling the selected external electronic device 505.

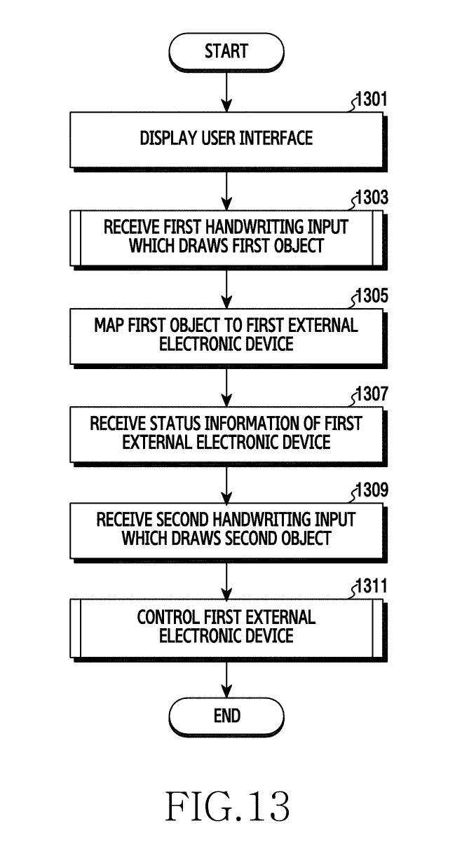

FIG. 13 is a flowchart illustrating operations of an electronic device for controlling an external electronic device using a user's handwriting input according to various embodiments of the present disclosure.

Operations 1301 and 1303 are similar to operations 1201 and 1203 and thus shall not be further described.

In operation 1305, a control unit (e.g., the control unit 600 of FIG. 6) of an electronic device (e.g., the electronic device 501 of FIG. 5) may map the external electronic device 505 to a first object.

According to an embodiment, the first object is the shape displayed on the display 160 according to a combination of one or more basic geometrical elements, and mapping the external electronic device 505 to the firs object may indicate mapping the first object to the external electronic device 505, in order to control the external electronic device 505 using a user input which is received while the first object is displayed.

In operation 1307, the control unit 600 may receive status information of the external electronic device 505.

According to an embodiment, the status information of the external electronic device 505 indicates a current status of the external electronic device 505, and may include ON/OFF information of the external electronic device 505, current task information of the external electronic device 505, or reservation information, if a reservation is set, of the external electronic device 505. For example, if the external electronic device 505 is a TV, status information of the TV may include at least one of ON/OFF information of the TV, current channel information of the TV, and setting information (e.g., termination in one hour).

According to another embodiment, the control unit 600 may identify status information of the electronic device 501, and the status information of the electronic device 501 may be identified in one of operations 1301 through 1305, not necessarily in operation 1307. The status information of the electronic device 501 may indicate a current status of the electronic device 501, and include at least one of current task information of the electronic device 501 and sensor information (e.g., location information, direction information, or illuminance information) of the electronic device 501.

In operation 1309, the control unit 600 may receive a second handwriting input which draws a second object.

According to an embodiment, like the first object, the second object may be a shape displayed on the display 160 according to a combination of one or more basic geometrical elements (points or lines). For example, the second object may be a figure, a character, a number, or a combination of them.

According to another embodiment, the first object and the second object may be distinguished based on time. For example, the control unit 600 may determine an initial object on the display 160 which is not displaying any separate object, as the first object. For example, the control unit 600 may determine an additional object which is input while a separate object is displayed, as the second object.

According to yet another embodiment, the second object may be displayed on the display 160 in addition to the first object, displayed over at least part of the first object, or displayed outside the first object.

In operation 1311, the control unit 600 may control the external electronic device 505, based on at least one of characteristic information of the second handwriting input, status information of the electronic device 501, and the status information of the external electronic device 505.

In an embodiment, before controlling at least one of the external electronic device 505 and the electronic device 501, the control unit 600 may determine the characteristic information of the second handwriting input. The characteristic information of the second handwriting input may include at least one of the shape of the second object, a position of the second object on the display 160, a writing pressure of the second object, a writing speed of the second object, a pen tilt of the second object, a direction of the second object, a thickness of the line of the second object, and a stroke length of the second object. According to an embodiment, if the second object is a character or a number, the shape of the second object may indicate a character or a numeral value.

In another embodiment, based on at least one of the characteristic information of the second handwriting input which draws the second object, the status information of the electronic device 501, and the status information of the external electronic device 505, the control unit 600 may determine an operation to be executed by the external electronic device 505, and parameter value information. According to an embodiment, the parameter value information may be additional information for specifying the operation of the external electronic device 505. For example, if the external electronic device 505 is a TV and the operation to execute is “volume control”, the parameter value information may be information about how many levels the volume is increased, that is, information about a volume control value. For example, if the external electronic device 505 is a smart lock device and the operation to execute is “unlock”, the parameter value information may be security information, that is, information about whether a security level required to unlock is satisfied.

According to yet another embodiment, the control unit 600 may determine the operation to be executed by the external electronic device 505, based on the shape of the second object or the direction of the second handwriting input, and determine the parameter value of the operation of the external electronic device 505, based on the shape of the second object or the input pressure of the second object. For example, it is assumed that the first object mapped to the external electronic device 505 (e.g., the TV) is displayed on the display 160 and the second handwriting input which draws the second object is received. The control unit 600 may determine the operation to be executed by the external electronic device 505, as “volume control”, based on the shape (e.g., a straight line) of the second object or the direction (e.g., up) of the second handwriting input, and determine the parameter value, that is, “volume control value” of the operation of the external electronic device 505, based on the shape (e.g., the straight line) of the second object or the input pressure of the second object.

According to still another embodiment, the control unit 600 may transmit to the server 503, information of the operation to be executed by the external electronic device 505 and the parameter value of the operation. For example, if displaying the first object mapped to the external electronic device 505 (e.g., the TV) on the display 160 and receiving the second handwriting input which draws the second object, the control unit 600 may determine the operation of the external electronic device 505 to “mute”, based on the shape and the input direction of the second object. Hence, using a communication unit (e.g., the communication unit 620 of FIG. 6), the control unit 600 may transmit to the server 503, control information for muting the external electronic device 505.

According to still another embodiment, based on at least one of the characteristic information of the second handwriting input which draws the second object, the status information of the electronic device 501, and the status information of the external electronic device 505, the control unit 600 may control an electronic device which is different from the external electronic device 505, along with the external electronic device 505. According to an embodiment, the electronic device which is different from the external electronic device 505 may include the electronic device 501. According to still another embodiment, if the external electronic device 505 is the first external electronic device 102, the electronic device different from the external electronic device 505 may be the second external electronic device 104.

For example, if displaying the first object mapped to the external electronic device 505 (e.g., the TV) on the display 160 and receiving the second handwriting input which draws the second object, based on the shape and the input direction of the second object, the control unit 600 may determine the operation to be executed by the external electronic device 505 to “mute” and “transmit sound information to the electronic device 501” and determine the operation to be executed by the electronic device 501 to “output the sound information received from the external electronic device 505”. Hence, using the communication unit 620, the control unit 600 may transmit to the server 503, control information for causing the external electronic device 505 to “mute” and to “transmit sound information to the electronic device 501”, and control an input/output interface (e.g., the input/output interface 150 of FIG. 1) to output the sound information received from the server 503.

For example, if displaying the first object mapped to the first external electronic device 102 (e.g., the TV) and the second object mapped to the second external electronic device 104 (e.g., a refrigerator) on the display 160 and receiving a user input which moves the first object to overlap at least part of the second object, the control unit 600 may transmit, using the communication unit 620, to the server 503, control information for making the first external electronic device 102 “stop playing” and “transmit screen and sound information to the second electronic device 104”, and transmit control information for making the second external electronic device 104 “output the screen and sound information received from the first electronic device 102”. Hence, a screen of the refrigerator may display a broadcast which is being displayed on the TV.

For example, if the display 160 displays the first object mapped to the first external electronic device 102 (e.g., a bulb) and the second object mapped to the second external electronic device 104 (e.g., a bulb) and the first external electronic device 102 and the second external electronic device 104 are identical (e.g., the shape information 703 and the action information 707 corresponding to the first external electronic device 102 and the second external electronic device 104 are identical), the control unit 600 may group and control the first external electronic device 102 and the second external electronic device 104 based on a user's handwriting input. For example, if receiving a handwriting input which draws a closed curve (e.g., a circle) including the first object and the second object, the control unit 600 may group the first external electronic device 102 and the second external electronic device 104. Next, based on a user's additional input (e.g., a second handwriting input), the control unit 600 may control (e.g., turn off) the first external electronic device 102 and the second external electronic device 104 at the same time.

Although not depicted, after controlling the external electronic device 505, the control unit 600 may store the first object and the second object in a storage (e.g., the storage unit 630 of FIG. 6). According to an embodiment, the control unit 600 may store the first object by mapping it to the external electronic device 505, and store the second object by mapping it to the operation to execute and the parameter value of the operation.

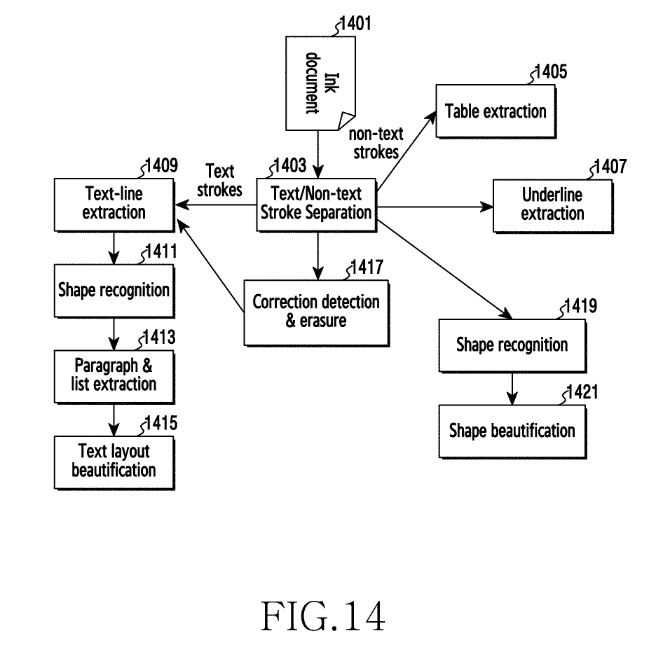

FIG. 14 is a diagram illustrating a concept for recognizing a shape of a first object or a second object in an electronic device according to various embodiments of the present disclosure.

According to an embodiment, upon receiving a user's handwriting input in operation 1401, a control unit (e.g., the control unit 600 of FIG. 6) of an electronic device (e.g., the electronic device 501 of FIG. 5) may determine whether the input draws an object on the display 160 or modifies an object on the display 160.

According to an embodiment, if the user input draws an object on the display 160, the control unit 600 may determine or update object candidates every time a stroke is input. According to an embodiment, the control unit 600 may determine whether the object is text or non-text in operation 1403. The text may include characters in one or more letters (e.g., English alphabet, consonants or vowels of Hangeul, characters created by combining consonants and vowels, or numbers). In response to the text object, the control unit 600 may extract a text line in operation 1409, recognize a shape of the text or a paragraph based on the extracted line in operations 1411 and 1413, and beautify a layout in operation 1415.

According to another embodiment, in response the non-text object, the control unit 600 of the electronic device may determine whether an attribute of the object is a table, an underline, or a shape in operations 1405, 1407, and 1419, and extract a meaning of the object according to the determined attribute. According to yet another embodiment, the control unit 600 of the electronic device, upon determining the object attribute as the shape, may recognize the object shape in operation 1419 and beautify the layout of the recognized shape in operation 1421.

According to still another embodiment, if the user input modifies the object displayed on the display 160, the control unit 600 of the electronic device may erase or modify the object displayed on the display 160 in operation 1417. Although not depicted, operation 1417 may be applied to the non-text, as well as the text.

According to a further embodiment, the object may include not only the first object but also the second object.

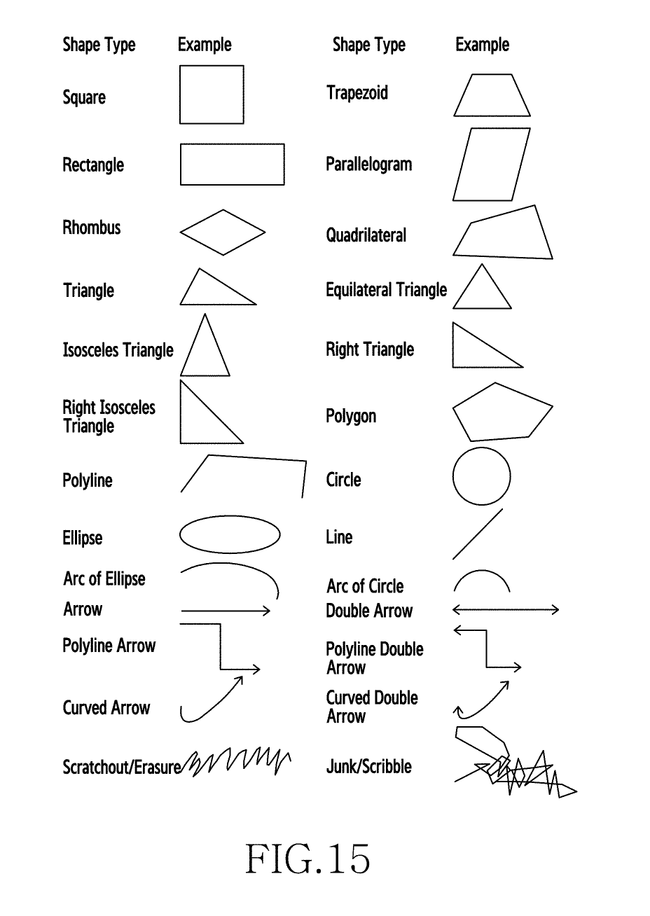

FIG. 15 is a diagram illustrating a concept for recognizing a shape of a first object or a second object in an electronic device according to various embodiments of the present disclosure.

According to an embodiment, the first object may be a shape displayed on the display 160 according to a combination of one or more basic geometrical elements (point or lines), for example, a figure.

According to an embodiment, the first object may include at least one of plane figures (a square, a trapezoid, a rectangle, a parallelogram, a rhombus, an equilateral triangle, a line, a circle, an ellipse, a polyline, or an arrow) of FIG. 15. For example, the electronic device may identify that the first object is a circle or an ellipse, based on the shape of the first object displayed on the display 160 according to a user input.

According to an embodiment, the plane figures of FIG. 15 may represent the shapes of not only the first object but also the second object.

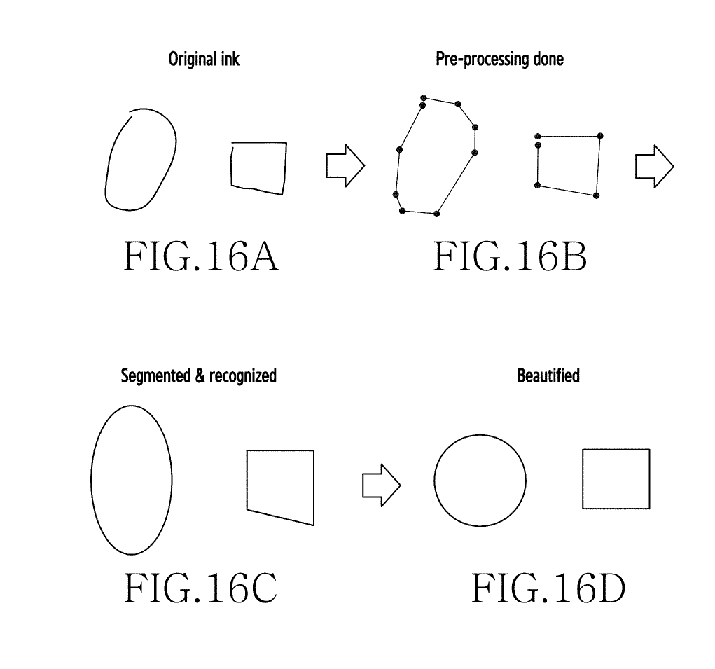

FIGS. 16A, 16B, 16C and 16D are diagrams illustrating a concept for determining a shape of an object in an electronic device according to various embodiments of the present disclosure.

In an embodiment, the object may include a first object and a second object.

In FIG. 16A, a control unit (e.g., the control unit 600 of FIG. 6) of an electronic device (e.g., the electronic device 501 of FIG. 5) may recognize an initial shape of an object which is input from a user, based on coordinate information of points touched by the user. For example, the initial shape of the object which is input from the user may be an incomplete ellipse or a distorted quadrangle.

In FIG. 16B, the control unit 600 may pre-process the initial shape of the object which is input from the user. The pre-processing may include extracting one or more points of the initial shape of the object which is input from the user, on a preset basis, at predetermined intervals, or at random. For example, the preset basis may be an intersection point of lines.

In FIG. 16C, based on positions of the one or more extracted points or based on a predetermined error range, the control unit 600 may select one of geometric figures which satisfy the one or more extracted points. For example, nine points extracted from the incomplete ellipse may represent a nonagon or an ellipse, and the control unit 600 may select the ellipse by considering that the initial shape of the object which is input from the user includes a curve, not a straight line.

In FIG. 16D, the control unit 600 may beautify a layout of the selected figure. For example, the control unit 600 may parallelize a straight line which is inclined within the predetermined error range, with a bottom side of the display 160. For example, if eccentricity of the ellipse is smaller than a preset value, the control unit 600 may correct the ellipse to a circle. For example, the control unit 600 may arrange one or more objects based on their center.

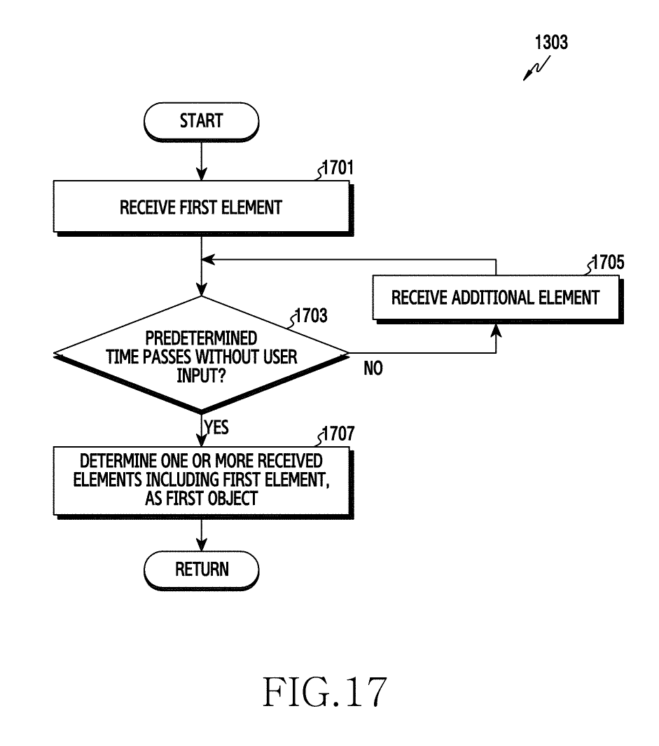

FIG. 17 is a flowchart illustrating operations of an electronic device for receiving a first handwriting input which draws a first subject according to various embodiments of the present disclosure.

FIG. 17 is a flowchart illustrating an operation (operation 1303 of FIG. 13) of the electronic device for receiving the first handwriting input which draws the first subject.

In operation 1701, a control unit (e.g., the control unit 600 of FIG. 6) of the electronic device (e.g., the electronic device 501) may receive a first element. An element is a plane figure including one or more points or lines, and the first element may be an initial element of the first handwriting input. For example, the first element may be a rectangle.

After receiving the first element, the control unit 600 may determine whether a predetermined time passes without a user's input in operation 1703. If identifying a user's input before the predetermined time elapses, the control unit 600 may receive an additional element based on the identified user input in operation 1705 and repeat operation 1703. If the predetermined time passes without a user's input, the control unit 600 may determine one or more received elements including the first element, as a first object in operation 1707.

That is, the control unit 600 may determine one or more elements which are input onto the display 160 until the predetermined time passes without a user's input, as the first object. Although not depicted, in response to a touch of a predetermined button or an icon, which terminates the input, the control unit 600 may determine one or more elements which are input onto the display 160, as the first object though the predetermined time does not elapse.

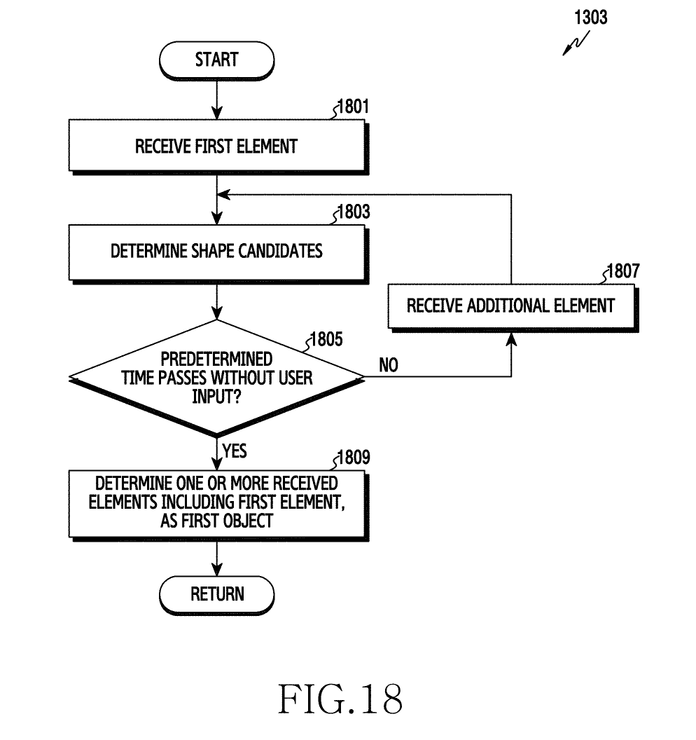

FIG. 18 is a flowchart illustrating operations of an electronic device for receiving a first handwriting input which draws a first subject according to various embodiments of the present disclosure.

FIG. 18 is the flowchart illustrating the operation (operation 1303 of FIG. 13) of the electronic device for receiving the first handwriting input which draws the first subject.

In operation 1801, a control unit (e.g., the control unit 600 of FIG. 6) of the electronic device (e.g., the electronic device 501) may receive a first element. The first element may be a plane figure including one or more points or lines. For example, the first element may be a rectangle.

In operation 1803, the control unit 1803 may determine shape candidates including one or more elements received, among shapes stored in a first storage area.

In an embodiment, the first storage area may store the shape information 703 in a storage (e.g., the storage unit 630 of FIG. 6).

In another embodiment, the shape candidates include one or more elements which are received up to now, among the shapes 803 of the shape information 703, and may correspond to external electronic devices which may be mapped to an object input from the user. For example, if the input element is a rectangle, the shape candidates may include shapes including the rectangle, of a floor-standing air conditioner, a wall-mounted air conditioner, a multi-split system, an air purifier, a washer, a dryer, and an oven.

In operation 1805, the control unit 600 may determine whether a predetermined time passes without a user's input. If identifying a user's input before the predetermined time elapses, the control unit 600 may receive an additional element based on the identified user input in operation 1807 and repeat operation 1803. For example, if the first element is a rectangle, the shape candidates include shapes of a floor-standing air conditioner, a wall-mounted air conditioner, a multi-split system, an air purifier, a washer, a dryer, and an oven, and the additional element is a circle, the shape candidates may be changed by including only the shapes of the floor-standing air conditioner, the washer, and the dryer, which include the rectangle and the circle.

If the predetermined time passes without a user's input in operation 1805, the control unit 600 may determine one or more received elements including the first element, as a first object in operation 1809. For example, the control unit 600 may determine the shape including the rectangle and the circle, as the first object.

Although not depicted, the control unit 600 may determine the determined shape candidates, as shapes corresponding to the first object. For example, the control unit 600 may determine one or more shapes corresponding to the first object, as the shapes of the floor-standing air conditioner, the washer, and the dryer.

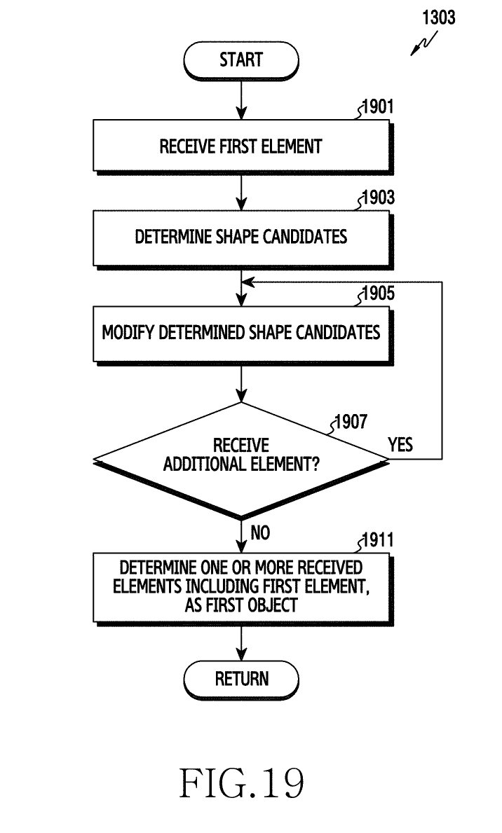

FIG. 19 is a flowchart illustrating operations of an electronic device for receiving a first handwriting input which draws a first subject according to various embodiments of the present disclosure.

FIG. 19 is the flowchart illustrating the operation (operation 1303 of FIG. 13) of the electronic device for receiving the first handwriting input which draws the first subject.

In operation 1901, a control unit (e.g., the control unit 600 of FIG. 6) of the electronic device (e.g., the electronic device 501) may receive a first element. The first element may be an initial element of the first handwriting input. For example, the first element may be a circle.

In operation 1903, the control unit 600 may determine shape candidates including the first element, among shapes stored in a first storage area. For example, the control unit 600 may determine one or more shapes including the circle, among the shapes 803 of the shape information 903 of a storage (e.g., the storage unit 630 of FIG. 6), as the shape candidates (shapes of a washer, a dryer, and a robot cleaner).

In operation 1905, the control unit 600 may modify the determined shape candidates. According to an embodiment, the control unit 600 may modify the shape candidates based on a relationship between the first element and the display 160 in operation 1905. The relationship between the first element and the display 160 may be information about whether relative positional relations between the first element and other elements may be identically applied to the first element displayed on the display 160, considering a size of the display 160. The relative positional relations may include inclusion and a size proportion of the elements.

For example, if the first element is the circle which almost fills the display 160, the control unit 600 may modify the shape candidates by excluding the washer and the dryer from the shape candidates (the washer, the dryer, and the robot cleaner) including the circle. While the shapes of the washer and the dryer include a rectangle including the circle as the other element, the circle displayed on the display 160 is too big to display the rectangle including the circle on the display 160.

According to another embodiment, in operation 1905, the control unit 600 may modify the determined shape candidates, based on a geometrical characteristic of the first element. If the first element is a rectangle where a bottom side is shorter than a left side, the control unit 600 may modify the shape candidates by excluding the shape of the wall-mounted air conditioner from the shape candidates (e.g., the shapes of the floor-standing air conditioner, the wall-mounted air conditioner, the multi-split system, the air purifier, the washer, the dryer, and the oven) including the rectangle in operation 1903. This is because the bottom side is longer than the left side in the shape of the wall-mounted air conditioner.

In operation 1907, the control unit 600 may determine whether an additional element is received. Upon receiving the additional element, the control unit 600 may repeat operation 1905.

In an embodiment, the control unit 600 may modify the existing shape candidates, based on at least one of spatial relationships between the additional element and the existing elements, geometrical characteristics of additional elements, and relationships between the additional elements and the display 160.

According to an embodiment, the control unit 600 may modify the existing shape candidates, based on the spatial relationships between the additional element and the existing elements. The spatial relationship may include inclusion. For example, if the first element is a circle and the additional element is a rectangle including the circle, the control unit 600 may modify the existing shape candidates by excluding the shape of the robot cleaner from the existing shape candidates (the floor-standing air conditioner, the washer, the dryer, and the robot cleaner) including the circle and the rectangle. This is because the robot cleaner includes the rectangle in the circle.

According to another embodiment, the control unit 600 may modify the existing shape candidates, based on the relationship between the additional elements and the display 160 or the geometrical characteristics of additional elements, which is similar to modifying the shape candidates based on the relationship between the first elements and the display 160 or the geometrical characteristics of the first elements and thus shall not be further explained.

In operation 1911, the control unit 600 may determine one or more received elements including the first element, as the first object.

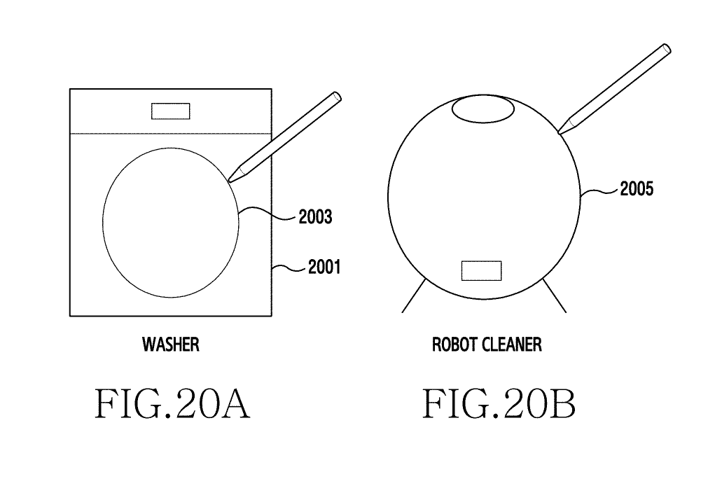

FIGS. 20A and 20B are diagrams illustrating modification of shape candidates in an electronic device according to various embodiments of the present disclosure.

In response to a user's handwriting input which draws a circle, a control unit (e.g., the control unit 600 of FIG. 6) of an electronic device (e.g., the electronic device 501 of FIG. 5) may determine a proportion of the circle on the display 160. For example, the control unit 600 may determine the proportion of the circle to an input region of the display 160. Also, the control unit 600 may determine shape candidates including the circle. For example, the control unit 600 may determine shapes of a washer (FIG. 20A) and a robot cleaner (FIG. 20B) as the shape candidates including the circle.

From the shape candidates, the control unit 600 may determine relatively positional relationships between the circle and other elements than the circle. For example, the control unit 600 may determine that the washer shape (FIG. 20A) of the shape candidates includes a rectangle 2001 including a circle 2003 and has the relatively positional relationship wherein the rectangle 2001 is 150% of the circle 2003 in size. For example, the control unit 600 may determine that the robot cleaner shape (FIG. 20B) of the shape candidates includes two straight lines outside a circle 2005 and has the relatively positional relationship wherein a length of the straight line is 20% of a radium of the circle 2005.

The control unit 600 may modify the existing shape candidates, based on the proportion of the circle to the display 160 and the relatively positional relationships between the circle and the other elements of the shape candidates. For example, if a handwriting input from the user is a circle occupying 90% of the display 160, the control unit 600 may exclude the washer shape (FIG. 20A) including the circle and the rectangle which is 150% of the circle in size, from the shape candidates.

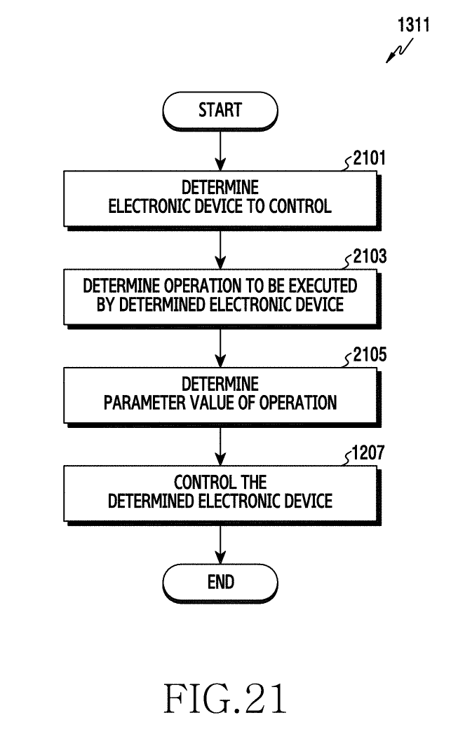

FIG. 21 is a flowchart illustrating operations of an electronic device for controlling at least one of an external electronic device and the electronic device according to various embodiments of the present disclosure.

FIG. 21 is the flowchart illustrating the operation (operation 1311 of FIG. 13) of the electronic device for controlling the external electronic device 505. In operation 2101, a control unit (e.g., the control unit 600 of FIG. 6) of the electronic device (e.g., the electronic device 501 of FIG. 5) may determine an electronic device to control.

According to an embodiment, the control unit 600 may determine at least one of the external electronic device 505 mapped to a first object and the electronic device 501, as the electronic device to control.

According to an embodiment, the control unit 600 may determine the electronic device to control, based on characteristic information of a second handwriting input which draws a second object. For example, the characteristic information of the second handwriting input may include a shape and a position of the second object on the display 160. For example, if the first object mapped to the external electronic device 505 is displayed on the display 160 and the second handwriting input which draws the second object is received, the control unit 600 may determine the electronic device to control, as the external electronic device 505, based on the position (e.g., inside the first object) of the second object on the display 160.

In operation 2103, the control unit 600 may determine an operation to be executed by the determined electronic device, based on the characteristic information of the second handwriting input which draws the second object, status information of the electronic device 501, or status information of the external electronic device 505.

According to an embodiment, the control unit 600 may determine the operation to be executed by the determined electronic device, by comparing the shape of the second object with the shapes of the action information 707. For example, if the first object mapped to the external electronic device 505 is displayed on the display 160 and the second handwriting input which draws the second object is received, the control unit 600 may determine the operation to be executed by the external electronic device 505, as “mute”, by comparing the shape (e.g., a speaker shape and a letter X) of the second object with the shapes of the action information 707.

In operation 2105, the control unit 600 may determine a parameter value of the operation determined, based on the characteristic information of the second handwriting input, the status information of the electronic device 501, or the status information of the external electronic device 505. For example, if the operation to be executed by the determined device is “volume control, the control unit 600 may determine a parameter value (e.g., volume up or down, control level, etc.) of “volume control”, based on a direction or the shape of the second handwriting input which draws the second object. For example, if the direction of the second handwriting input is up and the shape of the second object is a straight line which is 4cm in length, the control unit 600 may determine the parameter value, which is “increase the volume by two levels”, of “volume control”.

In operation 2107, the control unit 600 may control the determined electronic device based on the determined operation and parameter value. For example, the control unit 600 may transmit control information indicating the determined electronic device, the determined operation, and the parameter value, to the server 503, wherein the server 503 forwards a control command to the determined electronic device.

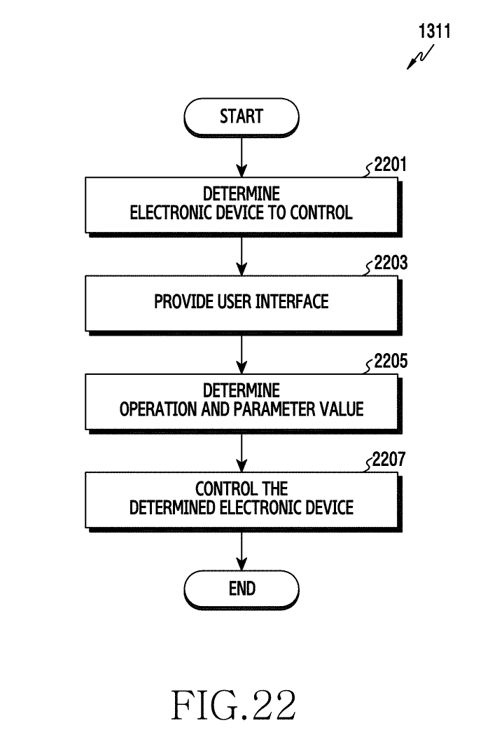

FIG. 22 is a flowchart illustrating operations of an electronic device for controlling at least one of an external electronic device and the electronic device according to various embodiments of the present disclosure.

FIG. 22 is the flowchart illustrating the operation (operation 1311 of FIG. 13) of the electronic device for controlling the external electronic device 505.

In operation 2201, a control unit (e.g., the control unit 600 of FIG. 6) of the electronic device (e.g., the electronic device 501 of FIG. 5) may determine an electronic device to control. According to an embodiment, the control unit 600 may determine at least one of the external electronic device 505 mapped to a first object and the electronic device 501, as the electronic device to control.

In operation 2203, the control unit 600 may provide a user interface for determining an operation based on characteristic information of a second handwriting input.

According to an embodiment, if not determining one operation to be executed by the determined electronic device by comparing a shape of the second object with the shapes of the action information 707, the control unit 600 may provide an additional user interface for determining the operation. For example, the control unit 600 may determine two or more shapes of the action information 707 and corresponding two or more operation information, based on the shape of the second object, and provide user interfaces for the two or more operation information determined, respectively. For example, if the second object of an up arrow shape is displayed outside the first object mapped to the external electronic device 505 (e.g., a TV), the control unit 600 may display user interfaces for controlling a channel and a volume of the TV respectively.

According to another embodiment, the control unit 600 may provide a user interface for determine an operation to execute and a parameter value of the operation.

According to still another embodiment, the control unit 600 may add a visual effect to the provided user interface. For example, the control unit 600 may display the user interface for the “channel control” and the user interface for the “volume control”, in different colors. For example, the control unit 600 may flicker the user interface to notify that the user interface is displayed.

In operation 2205, the control unit 600 may determine an operation to execute and a parameter value of the operation, based on a user input for the provided user interface. For example, according to a user's touch location in the user interface for the channel or volume control of the TV, the control unit 600 may determine the operation to execute, as “volume control” and determine the parameter value as “increase by two levels”.

In operation 2207, the control unit 600 may control the determined electronic device based on the determined operation and parameter value.

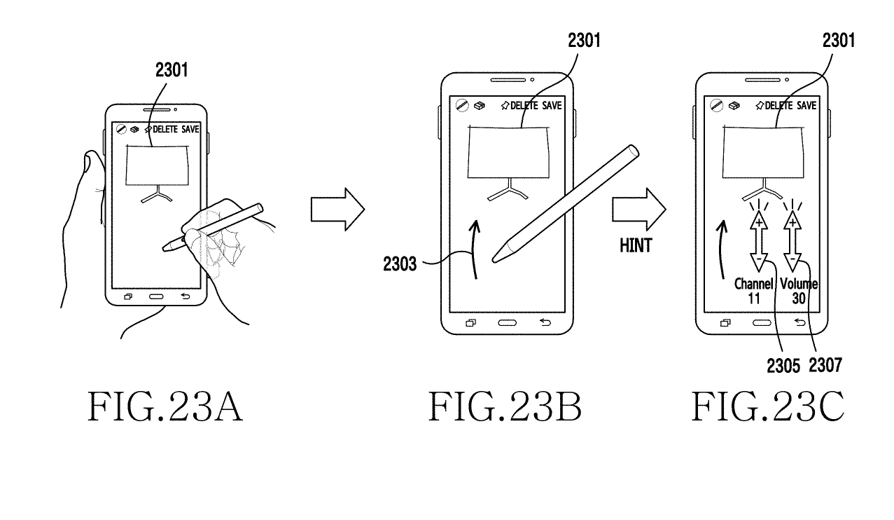

FIGS. 23A, 23B and 23C are diagrams illustrating a user interface provided by an electronic device to determine an operation and a parameter value according to various embodiments of the present disclosure.

In FIG. 23A, a control unit (e.g., the control unit 600 of FIG. 6) of an electronic device (e.g., the electronic device 501 of FIG. 5) may display a first object 2301 mapped to the external electronic device 505 (e.g., a TV), on the display 160.

In FIG. 23B, the control unit 600 may receive a second handwriting input which draws a second object 2303 of an up arrow shape outside the first object 2301.

In FIG. 23C, the control unit 600 may determine two or more shapes of the action information 707 and two or more operation information (e.g., channel control, volume control) corresponding to the shapes, based on the shape of the second object 2303, and provide objects 2305 and 2307 for the two or more determined operations information.

According to an embodiment, the control unit 600 may provide status information of the external electronic device 505 together with the user interface. For example, the control unit 600 may provide the user interfaces (e.g., the objects 2305 and 2307) for the channel control and the volume control and concurrently provide the status information indicating that a current channel is no. 11 and a current volume is 30.

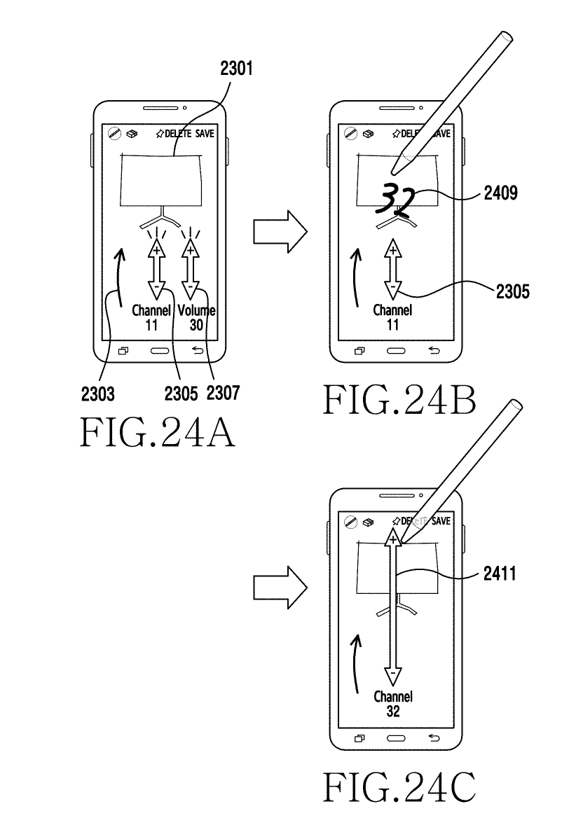

FIGS. 24A, 24B and 24C are diagrams illustrating an example where an electronic device determines an operation and a parameter value based on a user input for a user interface according to various embodiments of the present disclosure.

In FIG. 24A, in response to a second handwriting input which draws a second object 2303 of an up arrow shape outside a first object 2301 mapped to the external electronic device 505 (e.g., a TV), a control unit (e.g., the control unit 600 of FIG. 6) of an electronic device (e.g., the electronic device 501 of FIG. 5) may provide objects 2305 and 2307 for channel control and volume control, based on the shape of the second object 2303.

In FIG. 24B, the control unit 600 may determine an operation and a parameter value, according to a user input for the provided user interfaces (e.g., the objects 2305 and 2307). For example, if the user interface 2305 for the “channel control” is selected and then a separate user's handwriting input 2409 indicating a channel number (e.g., 32) to switch is received, the control unit 600 may determine the operation as “channel control” and determine the parameter value as “to: 32”. In another embodiment, if the user interface 2305 for the “channel control” is selected, the control unit 600 may hide the user interface 2305 for the “volume control” from the display 160.

In FIG. 24C, according to an embodiment, the provided user interfaces 2305 and 2307 may change their length or size according to the user input, and the changed length or size may determine the operation or the parameter value. For example, in response to a user input which increases the length of the user interface 2305 for the “channel control” upward (e.g., three times 2411), the control unit 600 may determine the operation as “channel control” and determine the parameter value of the operation as “increase the channel number by 10”. In another embodiment, in response to a user input which increases or decreases the length of the user interface 2305 for the “channel control”, the control unit 600 may not display the user interface 2307 for the “volume control” on the display 160 any more.

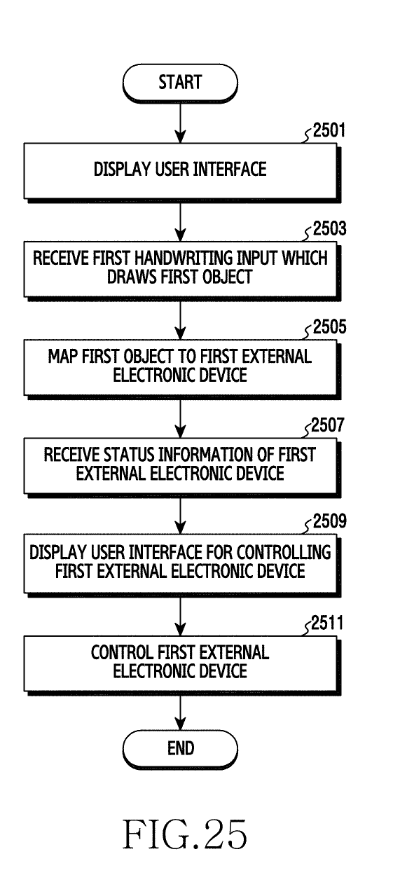

FIG. 25 is a flowchart illustrating operations of an electronic device for providing a user interface to control an external electronic device according to various embodiments of the present disclosure.

Operations 2501 through 2507 are similar to operations 1301 through 1307 of FIG. 13 and thus their explanations shall be omitted.

In operation 2509, a control unit (e.g., the control unit 600 of FIG. 6) of an electronic device (e.g., the electronic device 501) may display a user interface for controlling the external electronic device 505.

According to an embodiment, the control unit 600 may display status information of the external electronic device 505 together with the user interface for controlling the external electronic device 505. According to an embodiment, the status information of the external electronic device 505 indicates a current status of the external electronic device 505, and may include ON/OFF information of the external electronic device 505, current task information of the external electronic device 505, or reservation information if a reservation is set in the external electronic device 505.

According to another embodiment, the control unit 600 may display the status information of the external electronic device 505. The control unit 600 may display the status information of the external electronic device 505, at a predetermined position (e.g., inside) of a first object mapped to the external electronic device 505. For example, if the external electronic device 505 is the TV 407, the control unit 600 may display a playback bar indicating a current location of a current program on the TV 407, inside the first object. For example, the control unit 600 may display a channel list icon or a broadcast guide icon of the TV, inside or outside the first object or at a preset position.

According to yet another embodiment, the control unit 600 may display the user interface for controlling the external electronic device 505. For example, if the external electronic device 505 is the TV 407, the control unit 600 may display the user interface (e.g., a channel control icon, a volume control icon, etc.) for controlling the TV, inside the first object.

According to still another embodiment, the control unit 600 may display the user interface for controlling the external electronic device 505, at a predetermined position of the first object. For example, if the first object includes a rectangle and two straight lines below the rectangle by simplifying a shape of the external electronic device 505 (e.g., the TV), the user interface for controlling the TV may be positioned inside the rectangle. This is because the rectangle of the first object corresponds to a screen of the TV 407. Also, the user interface for controlling the TV may be disposed symmetrically in a vertical direction or in a horizontal direction within the rectangle.

According to a further embodiment, after the status information of the external electronic device 505 is received, if a predetermined time passes without a user input or a separate user input is detected in operation 2507, the control unit 600 may perform operation 2509.

Although not depicted, if displaying the status information of the external electronic device 505 or displaying the user interface for controlling the external electronic device 505 or the electronic device 501 in operation 2509, the control unit 600 may transmit to the external electronic device 505, a signal indicating that the status information or the user interface is displayed.

In operation 2511, the control unit 600 may control the external electronic device 505, based on a user input for the displayed user interface. For example, if the external electronic device 505 is the TV 407 and a user input for the TV channel list icon is detected, the control unit 600 may control the display 160 to display information of a current channel and available channels of the TV 407. For example, in response to a user input for the volume control icon, the control unit 600 may transmit to the server 503, control information based on the detected user input, wherein the TV 407 controls the volume.

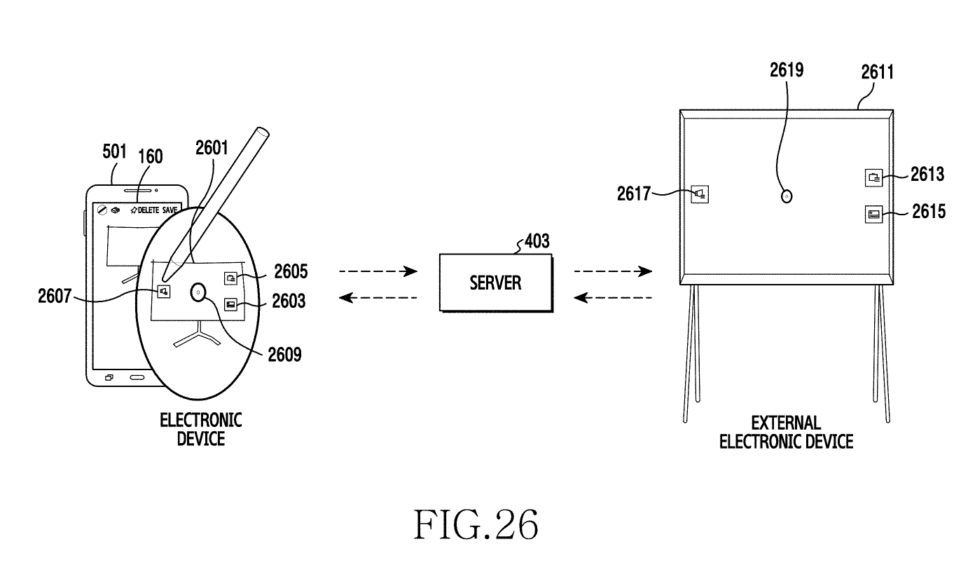

FIG. 26 is a diagram illustrating a user interface provided by an electronic device to control an external electronic device according to various embodiments of the present disclosure.

According to an embodiment, with a first object 2601 mapped to the external electronic device 505 (e.g., a TV) and displayed on the display 160, a control unit (e.g., the control unit 600 of FIG. 6) of the electronic device 501 may display user interfaces 2603, 2605, and 2607 for controlling the external electronic device 505 or the electronic device 501, inside or near the first object 2601. According to another embodiment, the control unit 600 may also display a user interface 2609 indicating status information of the electronic device. For example, the icon 2603 for executing broadcast guide, the icon 2605 for executing a channel list, and the icon 2607 for selecting a speaker may be displayed inside the first object 2601. In addition, the icon 2609 indicating ON/OFF of the electronic device may be displayed inside the first object 2601.

According to another embodiment, with the first object 2601 mapped to an external electronic device 2611 and displayed on the display 160, the control unit 600 may display a user interface for controlling the external electronic device 2611 or the electronic device 501, inside the first object 2601, in response to a predetermined time elapsed without a user input or in response to a separate user input. In so doing, the external electronic device 2611 may be the external electronic device 505.

According to another embodiment, a display of the external electronic device 2611 may also display user interfaces 2613, 2615, 2617 and 2619 which are identical to or correspond to the user interfaces 2603, 2605, 2607 and 2609, respectively, of the display 160 of the electronic device.

According to an embodiment, the server 403 may transmit information of the external electronic device 2611, to the electronic device 501, wherein the control unit 600 of the electronic device 501 displays the user interface for controlling the external electronic device 2611 or the electronic device 501. For example, if the external electronic device 2611 is a TV, the server 403 may transmit function information (e.g., play, stop or rewind) supported by the TV or status information of the external electronic device 2611, to the electronic device.

According to another embodiment, to display the user interfaces 2613 through 2619 which are identical to or correspond to the user interfaces 2603 through 2609 of the display 160 of the electronic device, on the display of the external electronic device 2611, the server 403 may transmit to the external electronic device 2611, position information of the user interfaces 2603 through 2609 on the display 160 of the electronic device.

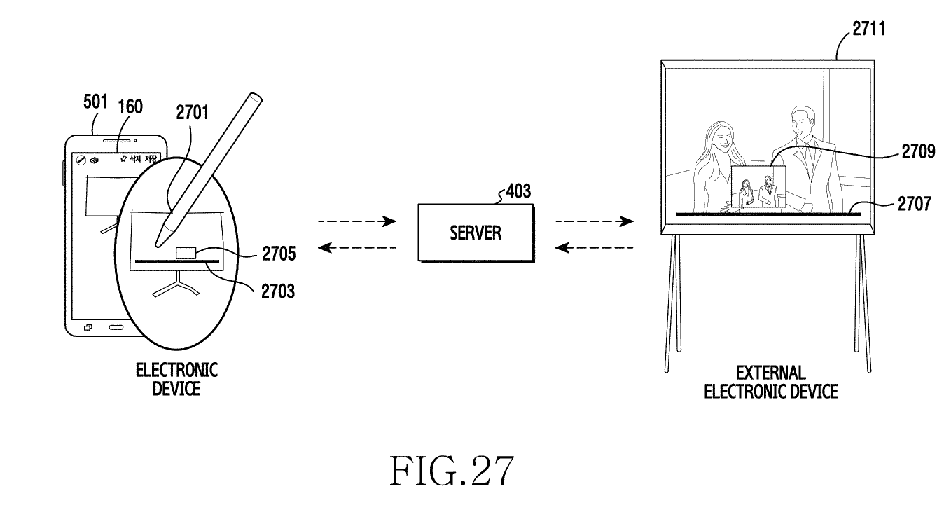

FIG. 27 is a diagram illustrating status information of an eternal electronic device, which is displayed at an electronic device according to various embodiments of the present disclosure.

According to an embodiment, with a first object 2701 mapped to an external electronic device 2711 (e.g., a TV) and displayed on the display 160, a control unit (e.g., the control unit 600 of FIG. 6) of the electronic device 501 may display status of the external electronic device 2711 at a predetermined position (e.g., inside) of the first object 2701. In so doing, the external electronic device 2711 may be the external electronic device 505.

For example, the control unit 600 may display a playback bar 2703 indicating playback location information of a current program of the TV, and the object 2705 indicating the current location, at predetermined positions (e.g., in a lower portion of the rectangle) of the first object.

According to another embodiment, if the electronic device 501 displays the status information of the external electronic device 2711 at the predetermined position of the first object 2701, the external electronic device 2711 may also display information corresponding to the status information displayed by the electronic device 501, on its display. For example, the TV 2711 may display a playback bar 2707 indicating the playback location information of the current program of the TV 2711 and the object 2709 indicating the current location, at predetermined positions (e.g., in a lower portion of the rectangle) of the display.

According to an embodiment, the server 403 may transmit the status information displayed at the electronic device 501, to the external electronic device 2711, or transmit the status information displayed at the external electronic device 2711, to the electronic device 501.

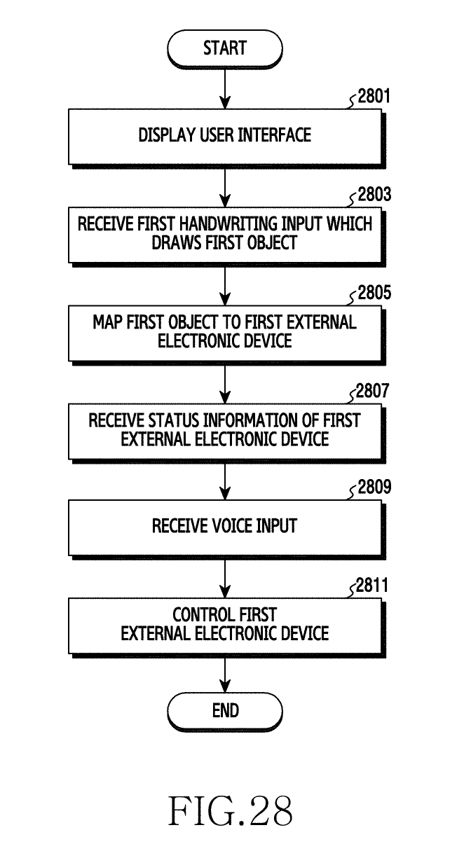

FIG. 28 is a flowchart illustrating operations of an electronic device for controlling an external electronic device based on a user's voice input according to various embodiments of the present disclosure.

Operations 2801 through 2807 are similar to operations 1301 through 1307 of FIG. 13 and thus their explanations shall be omitted here.

In operation 2809, a control unit (e.g., the control unit 600 of FIG. 6) of an electronic device (e.g., the electronic device 501 of FIG. 5) may receive a user voice input with a first object displayed. According to an embodiment, while the first object mapped to the external electronic device 505 is displayed, the control unit 600 may receive the user's voice input. For example, while the first object mapped to the external electronic device 505 (e.g., a TV), is displayed, the control unit 600 may receive a voice input such as “Capture the screen” from the user.

In an embodiment, the control unit 600 may convert the received user voice input to a text, identify that some word of the converted text is a keyword for controlling the external electronic device 505, and thus determine an operation to be executed by the external electronic device 505.

In another embodiment, the keyword for controlling the external electronic device 505 may be obtained by converting operation information of the action information 707 to a text. For example, the keyword for controlling the external electronic device 505 may include “Capture the screen”, “scheduled recording”, or “channel sharing”. For example, in response to the received voice input such as “Capture the screen”, the control unit 600 may identify that the text converted from the received voice input includes the keyword such as “Capture the screen” and thus determine the operation to execute, as “Capture the screen.”

In yet another embodiment, the control unit 600 may determine a parameter value of the operation, based on some word of the converted text. For example, in response to a voice input “Reduce volume by two levels” from the user, the control unit 600 may identify that the converted text includes the word “volume” and thus determine the operation to be executed by the external electronic device 505, as “volume control”. Also, by identifying the word “two levels”, the control unit 600 may determine the parameter value of “volume control”, as “two levels.”

In operation 2811, the control unit 600 may control the external electronic device 505, based on the user voice input. For example, the control unit 600 may transmit control information indicating the operation and the parameter value, which are determined based on the user voice input, to the server 503, wherein the server 503 forwards a control command to the external electronic device 505. For example, the control unit 600 may access the external electronic device 505 by referring to the device connection data 709 stored in a storage (e.g., the storage 630 of FIG. 6), and transmit control information indicating the operation and the parameter value, which are determined based on the user voice input, to the external electronic device 505.

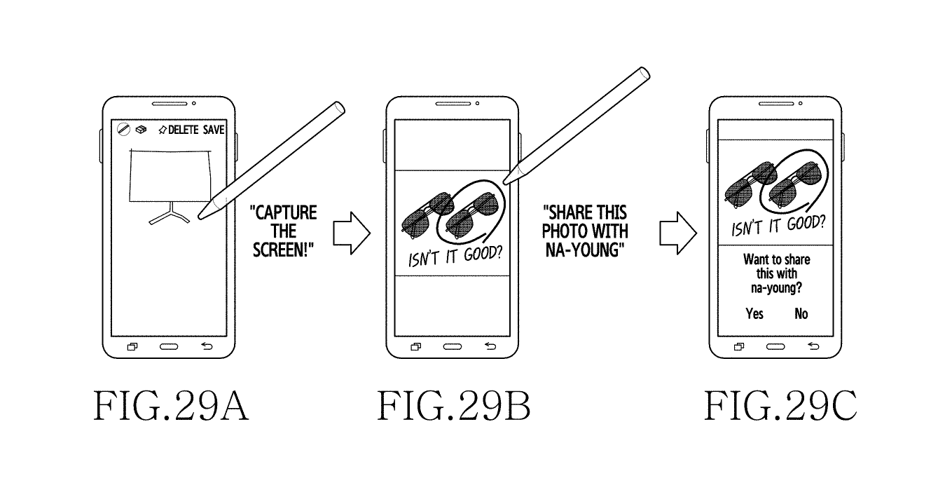

FIGS. 29A, 29B and 29C are diagrams illustrating an example where an electronic device controls an external electronic device based on a user's voice input according to various embodiments of the present disclosure.

In FIG. 29A, a control unit (e.g., the control unit 600 of FIG. 6) of an electronic device (e.g., the electronic device 501 of FIG. 5) may receive a user voice input while displaying a first object mapped to the external electronic device 505 (e.g., a TV). For example, the control unit 600 may receive a user voice input “Capture the screen.”

In an embodiment, based on the user voice input, the control unit 600 may determine an operation to be executed by the external electronic device 505. For example, the control unit 600 may convert the user voice input to a text, and then determine the operation to be executed by the external electronic device 505, as “Capture the screen”, based on the words “screen” and “capture” of the converted text.

In another embodiment, the control unit 600 may control the external electronic device 505 based on the user voice input. According to an embodiment, the control unit 600 may transmit control information indicating the operation (or a parameter value of the operation) determined based on the user voice input, to the server 503, wherein the server 503 forwards a control command to the external electronic device 505. For example, the control unit 600 may transmit to the server 503, control information including the time of the user voice and the operation (e.g., screen capture) information of the external electronic device 505.

In yet another embodiment, based on the control command received from the server 503, the external electronic device 505 may execute the operation and transmit result information to the server 503. The server 503 may transmit the result information received from the external electronic device 505, to the electronic device 501. For example, the TV which is the external electronic device 505 may capture the screen based on the control command received from the server 503. That is, the TV may capture the screen according to the time of the user voice, and transmit the captured screen to the electronic device 501 via the server 503.

In FIG. 29B, the control unit 600 may display the result information received from the server 503, on the display 160, and control the electronic device 501 to execute a specific operation based on an additional user input. In an embodiment, the additional user input may include a voice input or a handwriting input. For example, the control unit 600 may receive a handwriting input indicating a specific object and a voice input “Share this photo with Na-young”, in the result information displayed on the display 160.

In FIG. 29C, the control unit 600 may display a user interface for conducting “photo sharing”, on the display 160. For example, the control unit 600 may display a user interface for receiving a user selection, such as “Want to share this with Na-young?”, below a captured screen, and share the photo based on the user selection.

In another embodiment, to control the external electronic device 505 without the server 503, the control unit 600 may transmit control information directly to the external electronic device 505. For example, the control unit 600 may transmit directly to the external electronic device 505, information about a user voice time and an operation (e.g., screen capture) to be executed by the external electronic device 505.

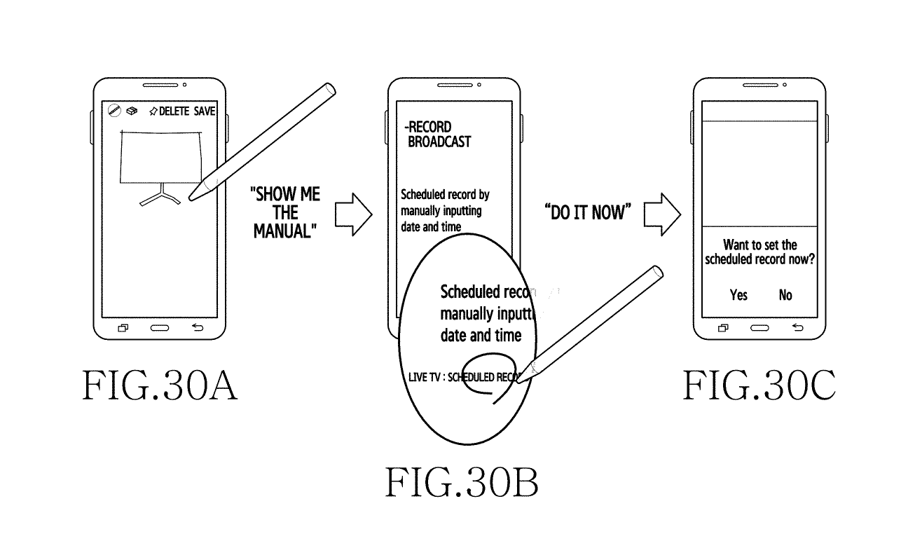

FIGS. 30A, 30B and 30C are diagrams illustrating another example where an electronic device controls an external electronic device based on a user's voice input according to various embodiments of the present disclosure.

In FIG. 30A, a control unit (e.g., the control unit 600 of FIG. 6) of an electronic device (e.g., the electronic device 501 of FIG. 5) may receive a user voice input while displaying a first object mapped to the external electronic device 505 (e.g., a TV). For example, the control unit 600 may receive a user voice input “Show me the manual.” Also, based on the user voice input, the control unit 600 may display a manual of the external electronic device 505, on the display 160. According to an embodiment, the manual may be pre-stored in a storage (e.g., the storage 630 of FIG. 6), downloaded from the server 503, or received from the external electronic device 505.

In FIG. 30B, the control unit 600 may control the electronic device 501 to execute a specified operation based on an additional user input relating to the manual displayed on the display 160. In an embodiment, the additional user input may include a voice input or a handwriting input. For example, in response to a handwriting input indicating a particular operation (e.g., scheduled recording) in the manual displayed on the display 160 and a voice input “Do it now”, the control unit 600 may display a user interface for executing the particular operation, on the display 160. That is, the control unit 600 may receive the additional user handwriting input and determine specific operation information (e.g., scheduled recording) according to coordinate information of the handwriting input.

In FIG. 30C, the control unit 600 may display a user interface for the external electronic device 505 to execute the determined operation, on the display 160. That is, the control unit 600 may display a user interface for receiving a user selection, such as “Want to execute the scheduled recording now?”, below a captured screen. According to an embodiment, the control unit 600 may transmit a control command to the external electronic device 505 based on the user selection.

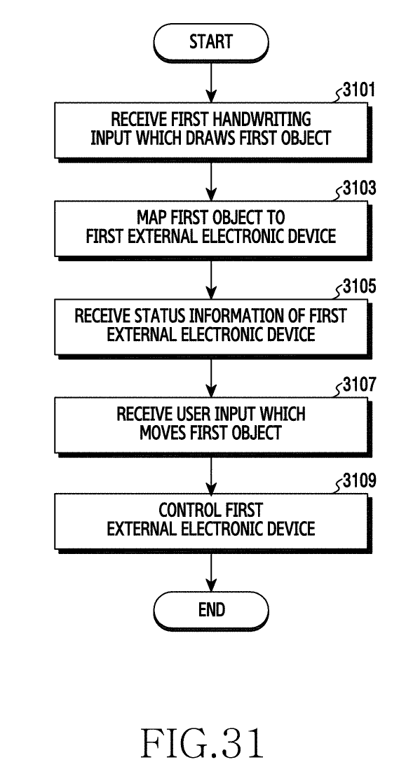

FIG. 31 is a flowchart illustrating operations of an electronic device for controlling an external electronic device according to various embodiments of the present disclosure.

Operations 3101 through 3105 are similar to operations 1301 through 1307 of FIG. 13 and thus their explanations shall be omitted here.

In operation 3107, a control unit (e.g., the control unit 600 of FIG. 6) of an electronic device (e.g., the electronic device 501) may receive a user input which moves a first object mapped to the external electronic device 505 (e.g., a TV).

According to an embodiment, the user input which keeps touching (e.g., long press) or pressing for a predetermined time at a specific location inside the first object may select the whole first object.

According to another embodiment, the user input which drags the whole first object to a specific length and releases the touch may move the first object.

In operation 3109, the control unit 600 may control the external electronic device 505 mapped to the first object, based on the moved position of the first object. For example, if the first object mapped to the TV and a second object mapped to the electronic device 501 are displayed on the display 160, in response to a user input which moves the second object to overlap at least part of the first object, the control unit 600 may control the electronic device 501 to forward a notification (e.g., a message) to the TV and the TV may display the notification received from the electronic device 501, on the display 160.

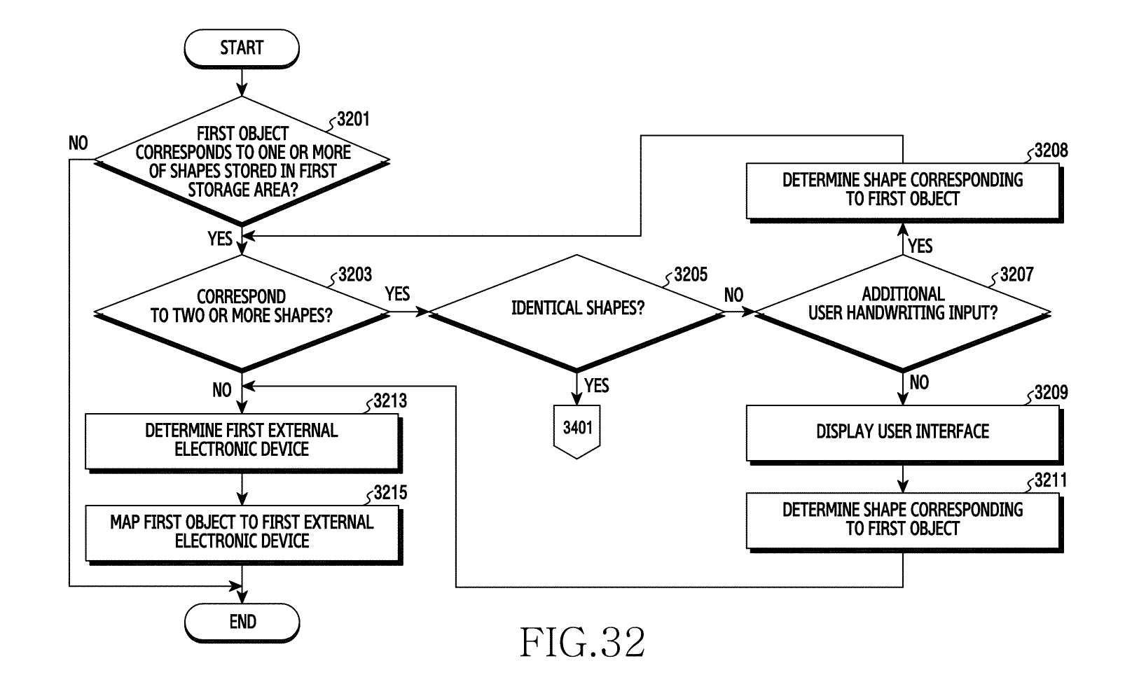

FIG. 32 is a flowchart illustrating operations of an electronic device for mapping a first object to an external electronic device according to various embodiments of the present disclosure.

In operation 3201, a control unit (e.g., the control unit 600 of FIG. 6) of an electronic device (e.g., the electronic device 501) may determine whether a first object displayed on the display 160 according to a first handwriting input corresponds to one or more of shapes stored in a first storage area. The first storage area may store the shape information 703 in a storage (e.g., the storage 630 of FIG. 6).

If the first object corresponds to one or more of the shapes stored in the first storage area in operation 3201, the control unit 600 may determine whether the first object corresponds to two or more of the shapes stored in the first storage area in operation 3203. If not, the first object corresponds to one of the shapes stored in the first storage area. Hence, the control unit 600 may determine the external electronic device 505 based on the one corresponding shape in operation 3213 and map the determined external electronic device 505 to the first object in operation 3215.

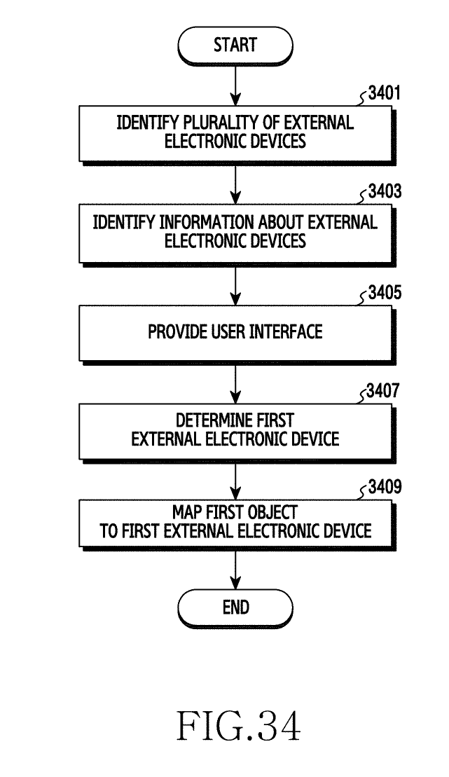

If the first object corresponds to two or more of the shapes stored in the first storage area in operation 3203, the control unit 600 may determine whether the two or more shapes are identical in operation 3205. The two or more identical shapes may indicate two or more external electronic devices of the same specifications. For example, the two or more identical shapes may indicate that the TVs of the same specifications are placed in the first bedroom, the second bedroom, and the third bedroom, respectively, of FIG. 9. In this case, the control unit 600 proceeds to operation 3401, to be explained in greater detail below with reference to FIG. 34.

If the two or more shapes corresponding to the first object are not identical in operation 3205, the control unit 600 may identify (determine) whether an additional user handwriting input is detected in operation 3207. For example, if the first object includes a circle and a rectangle including the circle, two or more shapes (e.g., a washer, a dryer) corresponding to the first object are not identical and accordingly the control unit 600 may identify whether the additional user handwriting input is detected in operation 3207.

In response to the additional user handwriting input in operation 3207, the control unit 600 may determine a shape corresponding to the first object in operation 3208. In an embodiment, the control unit 600 may update the first object by considering additional elements displayed by the additional user handwriting input, and re-determine the shape corresponding to the updated first object.

Next, the control unit 600 may return to operation 3203. According to an embodiment, the control unit 600 may repeat the operations 3203, 3205, 3207, and 3208 until an updated shape corresponding to the first object in which the additional user handwriting input is reflected corresponds to one of the shapes stored in the first storage area. For example, in response to the additional user handwriting input which inputs a watering pattern in a left direction of the circle, the control unit 600 may determine one shape corresponding to the first object, as a dryer shape.

If detecting no additional user handwriting input in operation 3207, the control unit 600 may provide a user interface for selecting one of the two or more shapes in operation 3209. In an embodiment, with the first object displayed on the display 160, the control unit 600 may display on the display 160, necessary elements for completing the first object as one of the two or more shapes.

In operation 3211, the control unit 600 may determine one shape corresponding to a user input for the user interface. For example, the control unit 600 may provide user interfaces corresponding to the washer shape and the dryer shape respectively, and, in response to a user touch input for the user interface corresponding to the dryer shape, determine the one shape corresponding to the first object, as the dryer shape. Next, the control unit 600, which determines the one shape corresponding to the first object, may determine the external electronic device 505 to be mapped to the first object based on the one corresponding shape in operation 3213. For example, the control unit 600 may determine the external electronic device 505 to be mapped to the first object, as the dryer. Next, the control unit 600 may map the first object and the dryer.

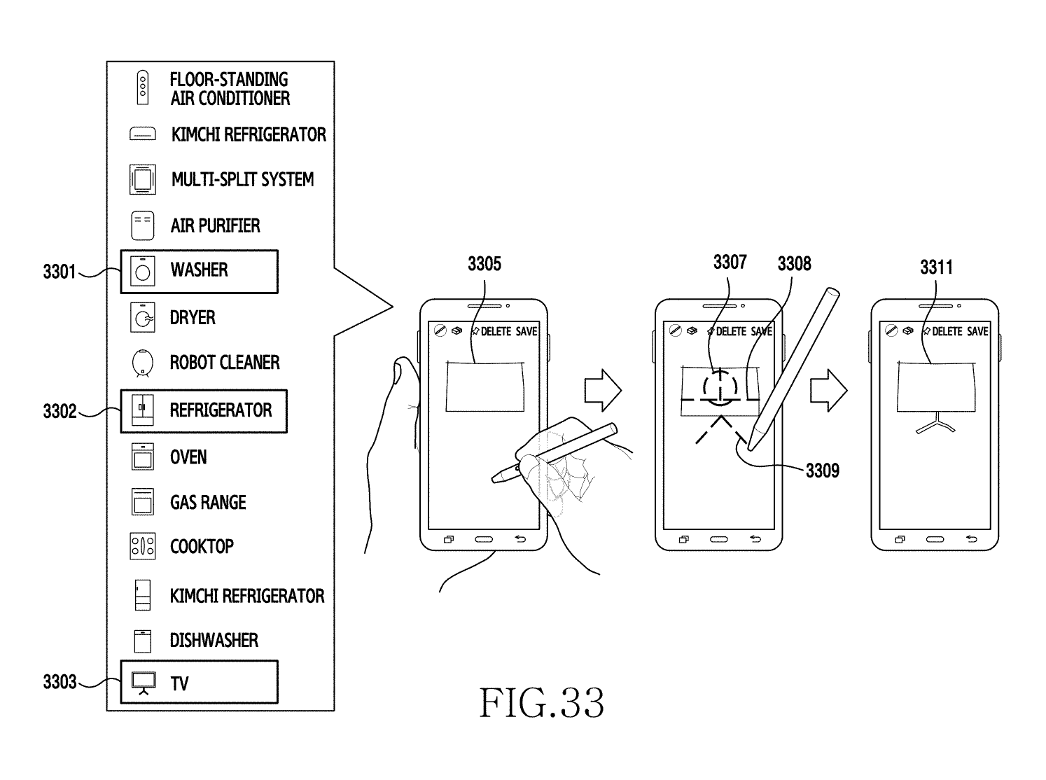

FIG. 33 is a diagram illustrating an example where an electronic device determines a shape of an external electronic device corresponding to a first object according to various embodiments of the present disclosure.

A control unit (e.g., the control unit 600 of FIG. 6) of an electronic device (e.g., the electronic device 501 of FIG. 5) may receive a first handwriting input which draws a first object 3305. For example, the control unit 600 may receive the first handwriting input which draws a rectangle.

If shapes in a first storage area include a plurality of shapes (a TV 3303, a washer 3301, and a refrigerator 3302) corresponding to the first object, the control unit 600 may provide a user interface for selecting one of the shapes.

In an embodiment, the user interface for selecting one of the shapes may display necessary elements to complete the first object as one of the shapes. For example, the control unit 600 may display a necessary element (two straight lines below a rectangle) 3309 for completing the first object (the rectangle) as a shape corresponding to the TV, a necessary element (a circle inside the rectangle) 3307 for completing the first object as a shape corresponding to the washer, and a necessary element (a straight line in parallel with a bottom side of the rectangle, and part of a perpendicular bisector of the parallel line) 3308 for completing the first object as a shape corresponding to the refrigerator.

According to an embodiment, the control unit 600 may display the user interface to be distinguished from the existing first object. For example, the user interface may be displayed with a dotted line which is distinguished from the first object of a solid line, or with a line in a different color or different thickness.

According to another embodiment, the control unit 600 may apply different colors to the necessary elements 3307, 3308, and 3309 for completing their shapes, to visually distinguish them.

The control unit 600 may determine one of the shapes, based on a user input for the provided user interface. For example, if the user touches the two straight lines 3309 below the first object (rectangle), the control unit 600 may determine one (TV shape) 3311 of the shapes. The control unit 600 may update the first object based on the user input, and map the updated first object to the external electronic device 505 corresponding to the determined shape.

FIG. 34 is a flowchart illustrating operations of an electronic device for determining an external electronic device to be mapped to a first object according to various embodiments of the present disclosure.

In operation 3401, a control unit (e.g., the control unit 600 of FIG. 6) of an electronic device (e.g., the electronic device 501) may identify a plurality of external electronic devices based on a plurality of shapes corresponding to a first object. According to an embodiment, the shapes may be identical, which may indicate presence of the external electronic devices of the same specifications (e.g., shape, performance, functionality, etc.). For example, the identical shapes may indicate that the TVs of the same specifications are placed in the second bedroom and the third bedroom respectively of FIG. 9.

In operation 3403, the control unit 600 may identify information about the identified external electronic devices, including, for example, at least one of location information, direction information, distance information, use frequency information, and use history information of the user. In an embodiment, the control unit 600 may use the location information 705 or the device connection data 709 of FIG. 7. Referring back to FIG. 9, for example, the control unit 600 may identify the frequency information that the user is presently located between the first bedroom and the second bedroom, is standing with the first bedroom on his/her left side, is closer to the TV of the second bedroom than the TV of the third bedroom, and controls the TV of the third bedroom more frequently than the TV of the second bedroom using the handwriting input.

In operation 3405, the control unit 600 may provide a user interface for determining the external electronic device 505 to control among the multiple external electronic devices, based on the identified information.

According to an embodiment, the control unit 600 may display on the display 160, the shapes corresponding to the external electronic devices, in different sizes or colors. For example, the control unit 600 may display on the display 160, the shapes indicating the TV 907 of the second bedroom and the TV 909 of the third bedroom, in different sizes based on the current distance from the user. For example, the control unit 600 may display on the display 160, the shapes indicating the TV 907 of the second bedroom and the TV 909 of the third bedroom, in different sizes or colors according to the frequency information.

In operation 3407, the control unit 600 may determine the external electronic device 505 to control, based on the user input for the user interface.

According to an embodiment, the external electronic device 505 to control is not limited to one device. For example, in response to the user input for the shape indicating the TV 907 of the second bedroom among the shapes of the TV 907 of the second bedroom and the TV 909 of the third bedroom, the control unit 600 may determine the external electronic device 505 to control, as the TV 907 of the second bedroom. For example, in response to the user input for the shapes of the TV 907 of the second bedroom and the TV 909 of the third bedroom, the control unit 600 may determine the external electronic device 505 to control, as the TV 907 of the second bedroom and the TV 909 of the third bedroom.

In operation 3409, the control unit 600 may map the first object to the external electronic device 505 to control. For example, the control unit 600 may map the first object to the TV 907 of the second bedroom.

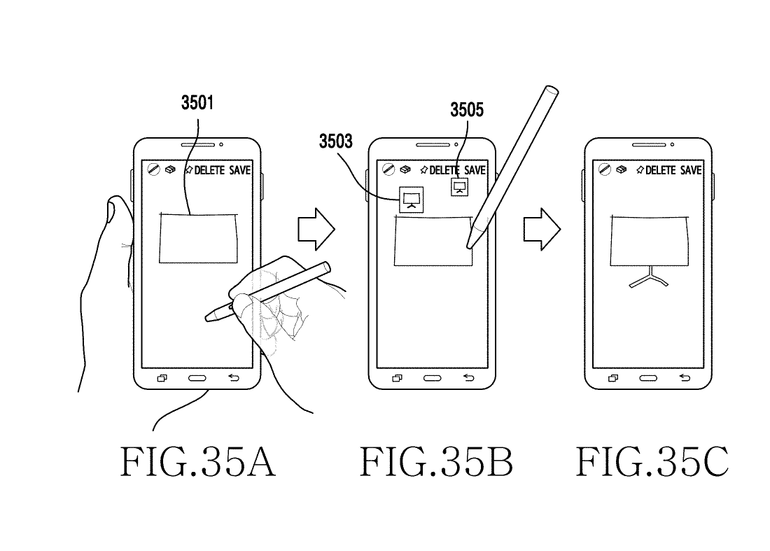

FIGS. 35A, 35B and 35 C are diagrams illustrating an example where an electronic device determines an external electronic device to be mapped to a first object according to various embodiments of the present disclosure.

In FIG. 35A, a control unit (e.g., the control unit 600 of FIG. 6) of an electronic device (e.g., the electronic device 501 of FIG. 5) may receive a first handwriting input which draws a first object 3501. For example, the first object 3501 may be a rectangle.

In FIG. 35B, if the shapes in the first storage area include identical shapes 3503 and 3505 corresponding to the first object, the control unit 600 may distinctively display the identical shapes 3503 and the 3505 based on at least one of location information, direction information, distance information, use frequency information, and use history information of the user. For example, based on the distance information from the electronic device 501, the control unit 600 may display the identical shapes 3503 and the 3505 in different sizes on the display 160. The shape 3503 may be large and the shape 3505 may be small in FIG. 35B. For example, referring back to FIG. 9, the large shape 3503 may indicate the TV 907 which is the closest to the electronic device, and the shape 5305 may indicate the TV 909 which is farthest from the electronic device. For example, the large shape 3503 may indicate the TV 907 of high use frequency, and the shape 5305 may indicate the TV 909 of low use frequency. For example, the large 3503 may indicate the TV 907 which is lately used.

According to an embodiment, the control unit 600 may determine the external electronic device 505 to control, based on a user input for the distinguished shapes 3503 and 3505. For example, in response to the user input for one 3505 of the distinguished shapes 3503 and 3505, the control unit 600 may determine the external electronic device 505 to control, as an electronic device corresponding to the shape 3505 of the detected user input. For example, referring back to FIG. 9, the control unit 600 may determine the external electronic device 505 to control, as the TV 909 in the third bedroom.

In FIG. 35C, the control unit 600 may update and map the first object to the determined external electronic device 505. For example, the control unit 600 may update the first object from the rectangle to the shape corresponding to the TV 909 of the third bedroom, and map the updated first object to the TV 909 of the third bedroom. In an embodiment, the control unit 600 may further display information about the updated first object and the mapped device (e.g., the TV 909). For example, the control unit 600 may further display the information of the updated first object and a type, a position, or a status (e.g., power status, channel status, or volume status) of the mapped device.

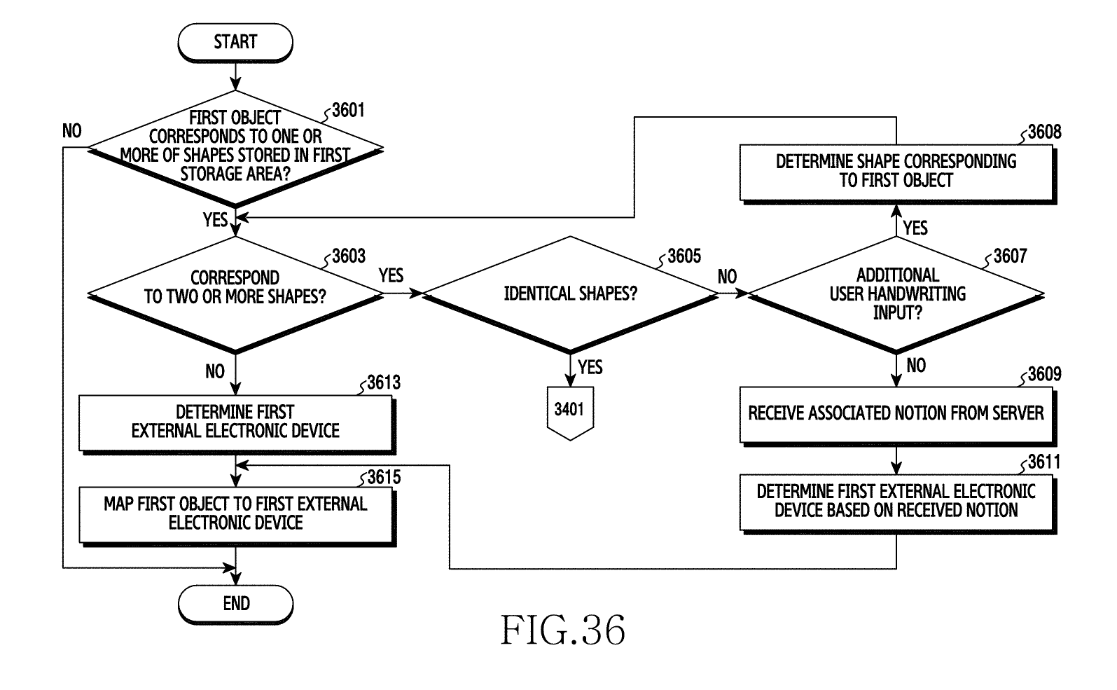

FIG. 36 is a flowchart illustrating operations of an electronic device for determining a shape of an external electronic device corresponding to a first object according to various embodiments of the present disclosure.

Other operations than operations 3609 and 3611 are similar to the other operations than operation 3209 and 3211 of FIG. 32 and thus their explanations shall be omitted here.

If a first object displayed according to a first handwriting input corresponds to two or more of shapes stored in a first storage area and an additional user handwriting input is not input to determine one of the two or more corresponding shapes, a control unit (e.g., the control unit 600 of FIG. 6) of an electronic device (e.g., the electronic device 501) may receive an associated notion from an external server (e.g., the server 503) based on the shape of the first object in operation 3609.

According to an embodiment, the external server, which is a server a knowledge base of a virtual world, may be an ontology server or a typical web server.

According to another embodiment, the control unit 600 may extract an associated word from the shape of the first object, enumerate associated words by applying ontology to the extracted word, and thus receive the associated notion from the external server based on the shape of the first object.

According to yet another embodiment, the control unit 600 may determine an electronic device corresponding to the shape of the first object, by searching the web server for the shape of the first object. For example, if the first object includes a rectangle and a circle in the rectangle, an intelligence unit (e.g., the intelligence unit 605 of FIG. 6) may search the ontology server for images of electronic devices of a category “home appliances”, and thus extract the associated word “washer” from the object shape displayed on the display 160. For example, if the shape of the first object includes a rectangle whose height is longer than its width and a circle in the rectangle, the control unit 600 may search the web server for the shape of the first object and thus determine a corresponding electronic device (e.g., an air conditioner).

In operation 3611, the control unit 600 may determine the first external electronic device 505 based on the received notion. For example, the control unit 600 may determine whether the determined notion is associated with a name of a specific electronic device by applying the ontology to the associated word of the first object shape, and if so, determine the specific electronic device as the first external electronic device.

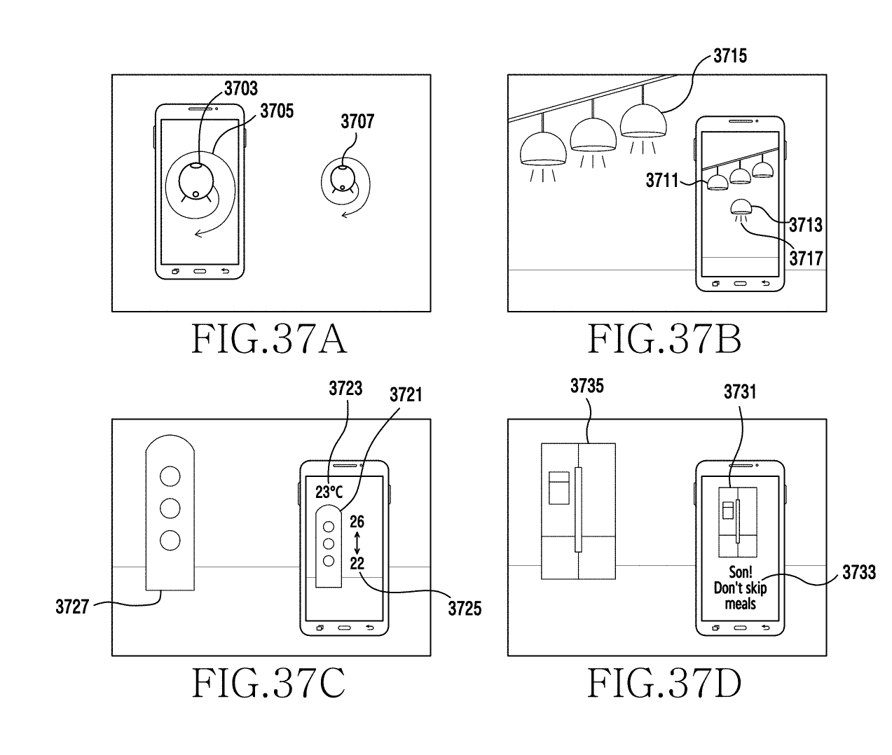

FIGS. 37A, 37B, 37C and 37D are diagrams illustrating an example where an electronic device controls an external electronic device according to various embodiments of the present disclosure.

Four specific diagrams of FIGS. 37A, 37B, 37C and 37D depict that a control unit (e.g., the control unit 600 of FIG. 6) of an electronic device (e.g., the electronic device 501 of FIG. 5) controls, if mapping the external electronic device 505 to a first object displayed according to a first handwriting input and receiving a second handwriting input which draws a second object to control the external electronic device 505, the external electronic device 505 based on characteristic information of the second handwriting input.

In FIG. 37A, if a robot cleaner 3707 is mapped to a first object 3703 displayed according to a first handwriting input and a second handwriting input which draws a second object 3705 is received to control the robot cleaner 3707, the control unit 600 may determine a travel path of the robot cleaner 3707 based on characteristic information of the second handwriting input (e.g., a shape of the second object 3705), and control the robot cleaner 3707 to clean up along the determined travel path.

In FIG. 37B, if a group of bulbs 3715 is mapped to a first object 3713 displayed according to a first handwriting input and a second handwriting input which draws a second object 3717 for controlling all of the bulbs 3715 is received, the control unit 600 may control the bulbs 3715 to turn on all of the bulbs 3715, based on characteristic information of the second handwriting input (e.g., a shape of the second object 3717).

In an embodiment, in response to the first handwriting input which draws the first object 3713, the electronic device may display an indication 3711 that the first object 3713 and the bulbs are mapped 3715, on the display 160.

In FIG. 37C, if an air conditioner 3727 is mapped to a first object 3721 displayed according to a first handwriting input, status information 3723 of the air conditioner 3727 is displayed, and a second handwriting input which draws a second object 3725 for controlling the air conditioner 3727 is received, the control unit 600 may control the air conditioner 3727 to maintain a temperature within a specific temperature range, based on characteristic information of the second handwriting input.

In FIG. 37D, if a refrigerator 3735 is mapped to a first object 3731 displayed according to a first handwriting input and a second handwriting input which draws a second object 3733 for controlling the refrigerator 3735 is received, the control unit 600 may control the refrigerator 3735 to display letters of the second object on its display, based on characteristic information of the second handwriting input.

A non-transitory computer readable recording medium may include, for example, a hard disk, a floppy disc, a magnetic medium (e.g., a magnetic tape), an optical storage medium (e.g., a compact disc-ROM (CD-ROM) or a DVD, a magnetic-optic medium (e.g., a floptical disc)), and an internal memory. The one or more instructions may include a code generated by a complier or a code executable by an interpreter. The module or program module may further include at least one or more components among the aforementioned components, or may omit some of them, or may further include additional other components. Operations performed by the module, the program, or another component may be carried out sequentially, in parallel, repeatedly, or heuristically, or one or more of the operations may be executed in a different order or omitted, or one or more other operations may be added.

According to various example embodiments, a method for operating an electronic device (e.g., the electronic device 501 of FIG. 5) may include providing a user interface for receiving a user handwriting input, receiving a first handwriting input which draws a first object through a display 160, determining a shape of the first object, selecting an external electronic device 505 to control, based on the shape of the first object, and establishing wireless communication with the external electronic device 505 to control, using a wireless communication circuit (e.g., the communication interface 170 of FIG. 1 or the communication module 220 of FIG. 2).

According to various example embodiments, the method may further include receiving a second handwriting input which draws a second object through the display, and determining a function to be executed by the external electronic device to control and a parameter value of the function, based on characteristic information of the second handwriting input.

According to various example embodiments, receiving the first handwriting input or receiving the second handwriting input may include receiving the handwriting input using the digitizer and a stylus pen which inputs the handwriting inputs to the digitizer.

According to various example embodiments, the characteristic information of the second handwriting input may include at least one of an intensity of the second handwriting input, a direction of the second handwriting input, a shape of the second object, and a position of the second object.

According to various example embodiments, selecting the external electronic device 505 to control based on the shape of the first object may include extracting one or more shapes including one or more elements of the first object, from a plurality of shapes in the electronic device, determining one or more external electronic devices corresponding to the one or more shapes extracted, and selecting one of the one or more external electronic devices, as the external electronic device to control.

According to various example embodiments, selecting one of the one or more external electronic devices, as the external electronic device to control may include receiving an additional user input in response to the one or more external electronic devices determined, and selecting one of the one or more external electronic devices, as the external electronic device to control, based on the received additional user input.

According to various example embodiments, selecting one of the one or more external electronic devices, as the external electronic device to control may include providing a guide regarding the one or more external electronic devices, in response to the one or more external electronic devices determined, wherein the additional user input may be related to the provided guide.

According to various example embodiments, providing the guide regarding the one or more external electronic devices may include providing the guide regarding the one or more external electronic devices, by displaying the first object on the display and displaying on the display, necessary elements for completing the first object as one of the one or more shapes determined.

According to various example embodiments, selecting the external electronic device to control based on the shape of the first object may include determining one or more shapes corresponding to the first object among a plurality of shapes in the electronic device, based on geometrical characteristics of one or more elements of the first object, a proportion to a display size, and relative positional relationships between the one or more elements, determining one or more external electronic devices corresponding to the one or more shapes determined, and selecting one of the one or more external electronic devices, as the external electronic device to control.

According to various example embodiments, selecting the external electronic device to control based on the shape of the first object may include, if the one or more shapes extracted are identical, determining one of the one or more shapes extracted, based on at least one of location information, direction information, distance information, use frequency information, and use history information, and selecting an external electronic device corresponding to the one shape, as the external electronic device to control.

According to various example embodiments, the external electronic device to control may include at least one of a first external electronic device and a second external electronic device, and determining the function to be executed by the external electronic device to control and the parameter value of the function may include determining a function to be executed by at least one of the first external electronic device and the second external electronic device, and a parameter value of the function.

As set forth above, an electronic device and its operating method according to various embodiments may control an external electronic device through a user input (e.g., handwriting) and thus enhance user convenience by easily selecting and controlling the electronic device based on a user's intention.

While the present disclosure has been illustrated and described with reference to various example embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a housing;
a touchscreen display exposed through the housing;
a communication circuit;
a processor disposed inside the housing and electrically coupled with the display and the wireless communication circuit; and
a memory disposed inside the housing and electrically coupled with the processor,
wherein the memory stores instructions which, when executed by the processor, cause the electronic device to provide a user interface configured to receive a user handwriting input, to receive a first handwriting input of a first object through the display, to determine a shape of the first object, to select an external electronic device to control based on the shape of the first object, and to establish wireless communication with the external electronic device to control, through the wireless communication circuit.

2. The electronic device of claim 1, wherein the memory further stores instructions which, when executed by processor, cause the electronic device to receive a second handwriting input of a second object through the display, and to determine a function to be executed by the external electronic device and a parameter value of the function, based on characteristic information of the second handwriting input.

3. The electronic device of claim 2, further comprising:
a digitizer comprising digitizing circuitry disposed inside the housing,
wherein the processor is configured to receive the first handwriting input and/or the second handwriting input, using the digitizer and a stylus pen configured to input the handwriting inputs to the digitizer.

4. The electronic device of claim 2, wherein the characteristic information of the second handwriting input of the second object comprises at least one of: an intensity of the second handwriting input, a direction of the second handwriting input, a shape of the second object, and a position of the second object.

5. The electronic device of claim 1, wherein the memory stores instructions which, when executed by the processor, cause the electronic device to extract one or more shapes comprising one or more elements of the first object from a plurality of shapes in the memory, to determine one or more external electronic devices corresponding to the one or more extracted shapes, and to select one of the one or more external electronic devices, as the external electronic device to control.

6. The electronic device of claim 5, wherein the memory stores instructions which, when executed by the processor, cause the electronic device to receive an additional user input in response to the one or more determined external electronic devices, and to select one of the one or more determined external electronic devices as the external electronic device to control, based on the received additional user input.

7. The electronic device of claim 6, wherein the memory further stores an instruction which, when executed by the processor, causes the electronic device to provide a guide for the one or more external electronic devices, in response to determining the one or more external electronic devices, and
the additional user input is related to the provided guide.

8. The electronic device of claim 7, wherein the memory further stores an instruction which, when executed by the processor, causes the electronic device to provide the guide for the one or more external electronic devices, by displaying the first object on the display and displaying on the display, elements for completing the first object as one of the one or more determined shapes.

9. The electronic device of claim 1, wherein the memory stores instructions which, when executed by the processor, cause the electronic device to determine one or more shapes corresponding to the first object from among a plurality of shapes in the memory based on geometrical characteristics of one or more elements of the first object, a proportion to a display size, and relative positional relationships between the one or more elements, to determine one or more external electronic devices corresponding to the one or more determined shapes, and to select one of the one or more external electronic devices as the external electronic device to control.

10. The electronic device of claim 5, wherein the memory stores instructions which, when executed by the processor, cause the electronic device, if the one or more shapes extracted are identical, to determine one of the one or more extracted shapes based on at least one of: location information, direction information, distance information, use frequency information, and use history information, and to select an external electronic device corresponding to the one shape, as the external electronic device to control.

11. The electronic device of claim 2, wherein the external electronic device to control comprises at least one of a first external electronic device and a second external electronic device, and
the memory stores instructions which, when executed by the processor, cause the electronic device to determine a function to be executed by at least one of the first external electronic device and the second external electronic device, and to determine a parameter value of the function.

12. A method for operating an electronic device, comprising:
providing a user interface configured to receive a user handwriting input;
receiving a first handwriting input of a first object through a display;
determining a shape of the first object;
selecting an external electronic device to control, based on the shape of the first object; and
establishing wireless communication with the external electronic device to control, using a wireless communication circuit.

13. The method of claim 12, further comprising:
receiving a second handwriting input of a second object through the display; and
determining a function to be executed by the external electronic device to control and a parameter value of the function, based on characteristic information of the second handwriting input,
wherein the characteristic information of the second handwriting input comprises at least one of: an intensity of the second handwriting input, a direction of the second handwriting input, a shape of the second object, and a position of the second object.

14. The method of claim 12, wherein selecting the external electronic device to control based on the shape of the first object comprises:
extracting one or more shapes comprising one or more elements of the first object from a plurality of shapes in the electronic device;
determining one or more external electronic devices corresponding to the one or more extracted shapes; and
selecting one of the one or more external electronic devices as the external electronic device to control.

15. The method of claim 14, wherein selecting one of the one or more external electronic devices as the external electronic device to control comprises:
receiving an additional user input in response to the one or more determined external electronic devices; and
selecting one of the one or more determined external electronic devices as the external electronic device to control based on the received additional user input.

16. The method of claim 15, wherein selecting one of the one or more external electronic devices, as the external electronic device to control comprises:
providing a guide for the one or more determined external electronic devices, in response to the one or more external electronic devices being determined,
wherein the additional user input is related to the provided guide.

17. The method of claim 16, wherein providing the guide regarding the one or more determined external electronic devices comprises:
providing the guide regarding the one or more determined external electronic devices, by displaying the first object on the display and displaying on the display elements for completing the first object as one of the one or more determined shapes.

18. The method of claim 12, wherein selecting the external electronic device to control based on the shape of the first object comprises:
determining one or more shapes corresponding to the first object from among a plurality of shapes in the electronic device based on geometrical characteristics of one or more elements of the first object, a proportion to a display size, and relative positional relationships between the one or more elements;
determining one or more external electronic devices corresponding to the one or more determined shapes; and
selecting one of the one or more external electronic devices, as the external electronic device to control.

19. The electronic device of claim 14, wherein selecting the external electronic device to control based on the shape of the first object comprises:
determining, if the one or more shapes extracted are identical, one of the one or more extracted shapes based on at least one of: location information, direction information, distance information, use frequency information, and use history information; and
selecting an external electronic device corresponding to the one shape as the external electronic device to control.

20. The method of claim 13, wherein the external electronic device to control comprises at least one of a first external electronic device and a second external electronic device, and
determining the function to be executed by the external electronic device to control and the parameter value of the function comprises:
determining a function to be executed by at least one of the first external electronic device and the second external electronic device, and a parameter value of the function.
